(19) United States
(12) Patent Application Publication
(10) Pub. No.: US 2020/0134717 A1
(43) Pub. Date: Apr. 30, 2020

(54) SYSTEMS AND METHODS FOR PERFORMING A FINANCIAL WELLNESS REVIEW

(71) Applicant: KeyBank National Association, Cleveland, OH (US)

(72) Inventors: Justin Hunsaker, Shaker Heights, OH (US); Jamie Warder, Cleveland, OH (US); David Glidden, Cleveland, OH (US); Katie Kaczmarski, Cleveland, OH (US); Arielle Cote-Colisson, Cleveland, OH (US); Ken Raskin, Cleveland, OH (US); Carolyn Houltham, Cleveland, OH (US); Raju Suddala, Cleveland, OH (US); Tanya Mitryakova, Cleveland, OH (US); Michael Goitein, Cleveland, OH (US); Michael Staudt, Cleveland, OH (US); Patrick Smith, Cleveland, OH (US); Mark Kolar, Cleveland, OH (US)

(21) Appl. No.: 16/665,876

(22) Filed: Oct. 28, 2019

Related U.S. Application Data
(60) Provisional application No. 62/751,203, filed on Oct. 26, 2018.
(60) Provisional application No. 62/915,997, filed on Oct. 16, 2019.

(51) Int. Cl. G06Q 40/02; G06Q 40/00

(52) U.S. Cl. CPC G06Q 40/025; G06Q 40/125

(57) ABSTRACT

A system and method for providing automated financial recommendations to a client includes storing to a memory a set of rules that define output financial recommendations based on a plurality of questions regarding the client's finances, providing the plurality of questions regarding the client's finances to a user via a user interface, receiving answers from the user to the plurality of questions via the user interface, storing the answers to a memory, calculating a set of financial recommendations based on the set of rules and the answers provided by the user, generating a report displaying the set of financial recommendations via the user interface. In one embodiment, the calculation of financial recommendations is further based upon information relating to the client's specific industry if the client is a business.

### RELATED APPLICATIONS

This non-provisional utility patent application claims priority to and the benefits of U.S. Provisional Patent Application Ser. No. 62/751,203, filed on Oct. 26, 2018, and entitled “Systems and Methods for Performing a Wellness Review of a Business” and U.S. Provisional Patent Application Ser. No. 62/915,997, filed on Oct. 16, 2019, and entitled “Systems and Methods for Performing a Wellness Review” which applications are incorporated herein by reference in their entirety.

### TECHNICAL FIELD

The present disclosure relates generally to the reviewing wellness of a client or client's business, and more specifically to systems and methods for creating customized solutions to enhance the client or client's business's financial wellbeing.

### BACKGROUND

Present solutions for providing financial products to businesses and consumers (“clients”) fail to properly assess those clients' actual needs. The current approach begins with an often-false assumption that a client's current set of financial products are optimal. A client is then offered a similar suite of products, perhaps at a slightly more competitive price. This approach, however, regularly fails to provide a set of products properly tailored to the needs of a specific client. Present approaches also inhibit development of a strong relationship between the client and the consulting party (e.g., a bank or financial services institution). Moreover, the consultant misses gathering key information it could use to tailor its products to similar clients in the future.

Rather than relying a client's current products, a better approach is to perform a wellness review of the client and to use the result of that review to derive a best set of financial products and recommendations for that client. This is no small task, however. Creating an optimal customized solution requires asking the right questions, providing a proper interface for collecting that information, and then using that information to derive a best set of financial products and recommendations. Specific systems and methods for achieving these goals are set forth herein.

### SUMMARY OF THE INVENTION

In a first embodiment of the present disclosure, a system for providing automated financial recommendations to a business includes a user interface having a plurality of questions regarding the business's finances and an input for the business to provide answers to the plurality of questions, an industry selector configured to input a specific industry for the business, and an output display. The system also includes a memory having stored thereupon data relating to general financial information for a plurality of industries, and a set of rules that define output financial recommendations based on the data relating to general financial information for a plurality of industries and the answers to the plurality of questions. The system further includes a processor configured to calculate and generate to the output display a set of financial recommendations based on the set of rules, the specific industry, and the answers to the plurality of questions.

In a second embodiment of the present disclosure, a system for providing automated financial recommendations to a consumer includes a user interface having a plurality of questions regarding the consumer's current financial assets and liabilities, an input for the consumer to provide answers to the plurality of questions regarding the consumer's current financial assets and liabilities, a plurality of questions regarding the consumer's financial behaviors, and an input for the consumer to provide answers to the plurality of questions regarding the consumer's financial behaviors. The system also includes an output display and a memory having stored thereupon a set of rules that define output financial recommendations based on the answers to the plurality of questions regarding the consumer's current financial assets and liabilities and the plurality of questions regarding the consumer's financial behaviors. The system further includes a processor configured to calculate and generate to the output display a set of financial recommendations based on the set of rules, the answers to the plurality of questions regarding the consumer's current financial assets and liabilities and the plurality of questions regarding the consumer's financial behaviors.

In a third embodiment of the present disclosure, a method for providing automated financial recommendations to a client includes storing to a memory a set of rules that define output financial recommendations based on a plurality of questions regarding the client's finances, providing the plurality of questions regarding the client's finances to a user via a user interface, receiving answers from the user to the plurality of questions via the user interface, storing the answers to a memory, calculating a set of financial recommendations based on the set of rules and the answers provided by the user, generating a report displaying the set of financial recommendations via the user interface.

### BRIEF DESCRIPTION OF THE DRAWINGS

FIG. 1 illustrates an exemplary embodiment of a computing system for carrying out a method of performing a financial wellness review.

FIG. 2 illustrates an exemplary method of performing a wellness review of a business.

FIG. 3 illustrates a screenshot of a user interface of a computing system for performing a first step of an exemplary method for performing a wellness review of a business, in which the screenshot shows the inputting of new client information for the business into the computing system such that the new client information can be used by an exemplary wellness review tool.

FIG. 4 illustrates another screenshot of the user interface of the computing system for performing another step of the method, in which the screenshot shows launching the exemplary wellness review tool for a business that has already had its client information entered into the computing system.

FIG. 5 illustrates another screenshot of the user interface of the computing system for performing another step of the method, in which the screenshot shows various features of the exemplary wellness review tool.

FIGS. 6-13 illustrate various screenshots of the user interface of the computing system for performing another step of the method, in which the screenshots show various questions for a first feature of the exemplary wellness review tool.

FIGS. 14-26 illustrate various screenshots of the user interface of the computing system for performing another step of the method, in which screenshots show various questions for a second feature of the exemplary wellness review tool.

FIGS. 27-31 illustrate various screenshots of the user interface of the computing system for performing another step of the method, in which the screenshots show data for a third feature of the exemplary wellness review tool.

FIGS. 32-35 illustrate various screenshots of the user interface of the computing system for performing another step of the method, in which the screenshots show various resources for a fourth feature of the exemplary wellness review tool.

FIGS. 36-38 illustrate various screenshots of the user interface of the computing system for performing another step of the method, in which the screenshots show various options for a fifth feature of the exemplary wellness review tool.

FIG. 39 illustrates an exemplary method of performing a wellness review of a consumer.

FIGS. 40-48 illustrate various screenshots of the user interface of the computing system for performing the method, in which the screenshots show various questions and results for a consumer financial wellness review tool.

### DETAILED DESCRIPTION

The Detailed Description describes exemplary embodiments of the invention and is not intended to limit the scope of the claims in any way. Indeed, the invention is broader than and unlimited by the exemplary embodiments, and the terms used in the claims have their full ordinary meaning. Features and components of one exemplary embodiment may be incorporated into the other exemplary embodiments. Inventions within the scope of this application may include additional features, or may have less features, than those shown in the exemplary embodiments.

The exemplary systems and methods described in the present application include exemplary embodiments of a wellness review tool, in which one or more business consultants (e.g., a bank or financial institution) and a client (e.g., a business owner or operator or consumer), either individually or together, utilize various features of the wellness review tool such that the consultant can provide the client with industry specific information and helpful resources and/or services that are customized to the client's financial needs. That is, the wellness review tool is configured to provide the consultant with various information about the client's financial needs based on the client's answering of questions about the client's business and operation of the business or the client's financial behaviors. In some embodiments, the wellness review tool is configured to utilize industry specific information to customize solutions to the client to help the client continue to operate and grow its business. In some embodiments, the wellness review tool is configured to utilize consumer behavior information to customize solutions to the client to help the client increase their personal financial wellbeing.

The systems and methods described herein are advantageous because they allow a client to interact with a wellness review tool and one or more consultants such that the consultants can provide the client with one or more customized solutions for the client. Instead of focusing a client's existing products to match them with new products, the wellness review tool is configured to obtain information about the client and, for a business, provide industry specific information and business solutions to the client based on the obtained information. For a consumer, the wellness review tool provides tailored information, products, services and solutions to the client based on the obtained information. The consultant helps the client provide the information such that the consultant learns important details regarding the client's information, and the consultant examines the information and solutions generated by the wellness review tool, such that the consultant can more effectively provide future consultation to the client.

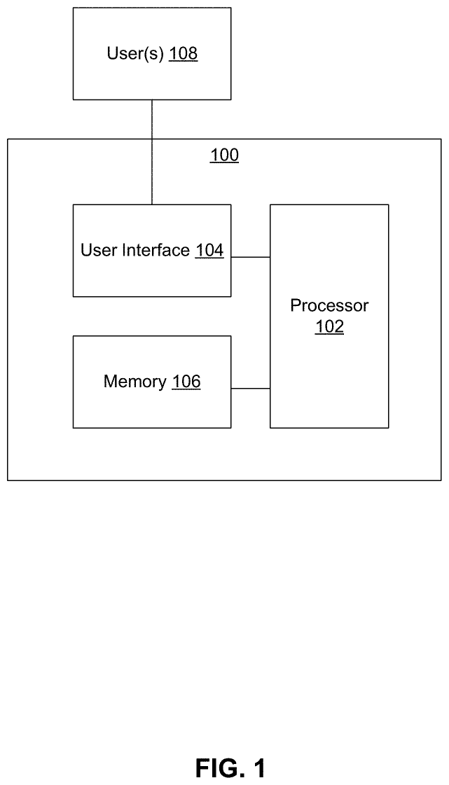

Referring to FIG. 1, an exemplary computing system 100 for carrying out a method of performing a financial wellness review (e.g., by using a wellness review tool) includes a processor 102, a user interface 104 and a memory 106. The computing device 100 can be, but is not limited to, a desktop computer, a kiosk, a tablet, a cell phone, or the like. The processor 102 can be configured to receive information regarding a client's business and/or finances, such that the information can be stored in the memory 106 of the computing device 100. The memory 106 is configured to store information obtained by the processor 102. The information can be information that is entered by the client or information that is entered by the consultant regarding (both of which may be user(s) 108), various products/services offered by the consultant, information obtained from the consultant regarding all of the consultant's clients, or any other information that is entered into the computing system. During use of any wellness review tool described herein, the processor can retrieve information from the memory 106 for use in performing the functions of the wellness review tool. It is also contemplated that the various components of the system 100 may be housed in different places. For example, the memory 106 maybe hosted through remote servers. The processor 102 can also be remote from the user (e.g., software as a service) with user interfacing with the wellness review tool through a web browser, terminal, or the like

The following disclosure pertains mainly to an embodiment of a wellness review tool optimized for the financial wellness of businesses. The consultant and wellness review tool are both able to obtain industry specific data from the business consultant's existing client's in the industry. In addition, the business consultants have expertise of both the industry and the products and services offered by the business consultant, which allows the business consultant to provide valuable solutions to the client. Also, the interaction between the client and the business consultant allows both the client and business consultant to make a determination as to whether the relationship between the parties is a good working relationship that should continue. Further, the systems and methods store the information collected during use of the tool. This information can later be used to analyze and identify the characteristics of potential customers who are, and are not, successfully converted to customers for one or more products.

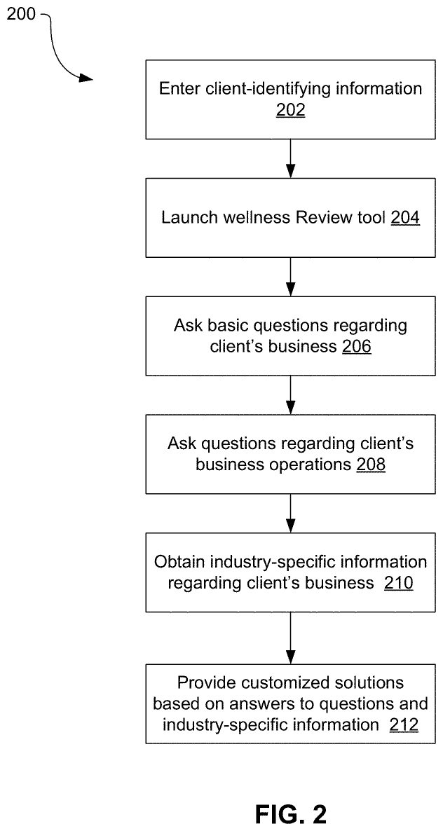

Referring to FIG. 2, an exemplary method 200 for performing a wellness review of a business includes entering a client's information into a computing system (as shown at box 202). Any suitable computing system can be used, such as, for example computing system 100 shown in FIG. 1. The client's information can include, for example, personal information (e.g., name, email address, telephone number, etc.) or information regarding the client's business (e.g., business name, business address, etc.). The method 200 further includes launching a wellness review tool using the computing system (as shown at box 204). The wellness review tool can include various features that allow data to be entered into the wellness review tool regarding the business, and the tool can include various other features that provides industry specific information and/or resources to the client. In certain embodiments, the method 200 is completed by a client and a business consultant using the wellness review tool together, and, in other embodiments, the client and the business consultant may use the wellness review tool separately.

After the client's information is entered and the wellness review tool is launched, the method 200 includes inputting answers into the wellness review tool in response to questions regarding the client's business (as shown at box 206). The questions can include, for example, questions regarding the motivation for starting the business, the goals and challenges of the business, the description of the business, the organization of the business, the amount of years that the business has been active, the number of employees, the anticipated sales, past sales, the competitive environment, the client's motivations or business goals, or any other relevant information regarding the client's business.

The method 200 further includes inputting answers into the wellness review tool in response to questions regarding the operation of the client's business (as shown at box 208). The questions can include, for example, questions regarding the number of anticipated transactions over a predetermined period of time, how the customers pay the business, the amount of time it takes for the customers to pay the business, the means by which the business makes payments, current resources and services utilized by the business, the type of software that the business uses, how the business keeps its accounting books, financing and/or investing needs of the business, plans for savings in the future, interests regarding benefits for owner and/or employees of the business.

In the steps of the method 200 described above with reference to boxes 206 and 208, in certain embodiments, the business consultant asks the questions to the client, and the business consultant inputs the answers into the wellness review tool. In other embodiments, the client receives the questions directly from the wellness review tool and inputs the answers directly into the wellness review tool. In some embodiments, the client and the business consultant are at the same location (e.g., a bank) when inputting the answers to the questions, and, in other embodiments, the client can input answers to the questions while at a remote location from the business consultant.

After inputting answers into the wellness review tool regarding the client's business and operation of the business, the method 200 includes providing the client with industry specific information (as shown at box 210) based at least in part on the answers inputted into the wellness review tool and in part on the business consultant's expertise regarding the industry. For example, based on the inputted answers, the wellness review tool will be able to provide statistics such as, the number of business in the industry, the amount of money in loans for the businesses in the industry, the number of transactions by businesses in the industry, and the amount of money in transactions for businesses in the industry. Exemplary logic for determining industry can be found in the attached Appendix.

The method 200 further includes the wellness review tool providing solutions to the client (as shown in box 212) based at least in part on the answers inputted into the wellness review tool (as discussed with reference to boxes 206 and 208), the industry specific information (as discussed with reference to box 210), and the business consultant's expertise. The solutions can include, for example, management of payments, management of funds, operational changes, obtaining loans, obtaining a credit card, obtaining a mortgage, opening new banking accounts (e.g., a checking account, savings account, money market account, CD account), obtaining protection (e.g., overdraft protection, fraud protection, insurance), or other business management services.

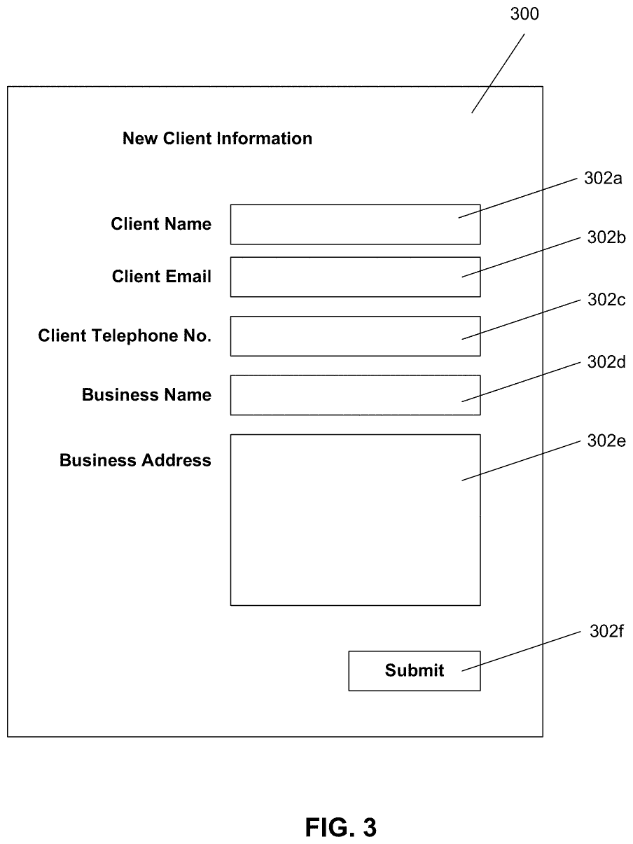

FIGS. 3-38 illustrate various screenshots for a user interface (e.g., any user interface described in the present application) of a computing device (e.g., any computing device described in the present application), in which the screenshots illustrate various features of an exemplary embodiment of a wellness review tool. The wellness review tool shown in FIGS. 3-38 will be described with reference to the method 200 described in FIG. 2 and the computing device 100 described with reference to FIG. 1. However, the wellness review tool is not limited to the method 200 and computing device 100.

Referring to FIG. 3, a first screenshot 300 is labeled as “New Client Information” and includes various input fields 302a-302e in which a user can input information about a new client via the user interface 104 of the computing device 100. This first screenshot 300 is configured such that the user can perform step labeled by box 202 in the method 200. The user can be the new client or one or more business consultants that are helping the new client. It should be understood that a new client may be a client with whom the employer of the business consultant has never done business, or a new client may be an existing client potentially in need of new products or services. In the illustrated embodiment, the input fields 302a-302e relate to the client's name, client's email, client's telephone number, the business's name, and the business's address. However, the “New Client Information” section of the wellness review tool can include any information about the new client that is relevant to the client's business and the relationship between the client and the business consultant. After the new client information is entered into the input fields 302a-302e, the user can click on the “Submit” link 304 to enter the new client information into the wellness review tool. In certain embodiments, clicking the “Submit” link 304 causes the processor 102 to store the information in the memory 106 of the computing device 100 such that, when the user launches the wellness review tool on the computing device, the wellness review tool has the new client information.

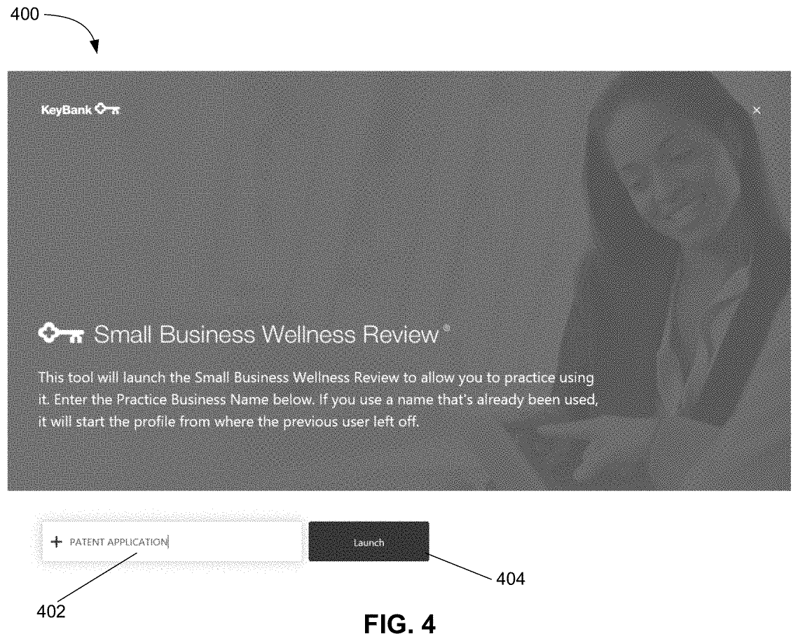

FIG. 4 illustrates a screenshot 400 for the wellness review tool that allows a user to launch the wellness review tool client that has already completed the “New Client Information” page described with respect to FIG. 3. The screenshot 400 includes a input field 402 for the name of the client's business. The screenshot 400 also includes a “Launch” link 404 that is used to launch the wellness review tool for the business that is entered into the input field 402. Therefore, in order to launch the wellness review tool for the client, the user enters a business name into the input field 402, and then the user clicks the “Launch” link 404.

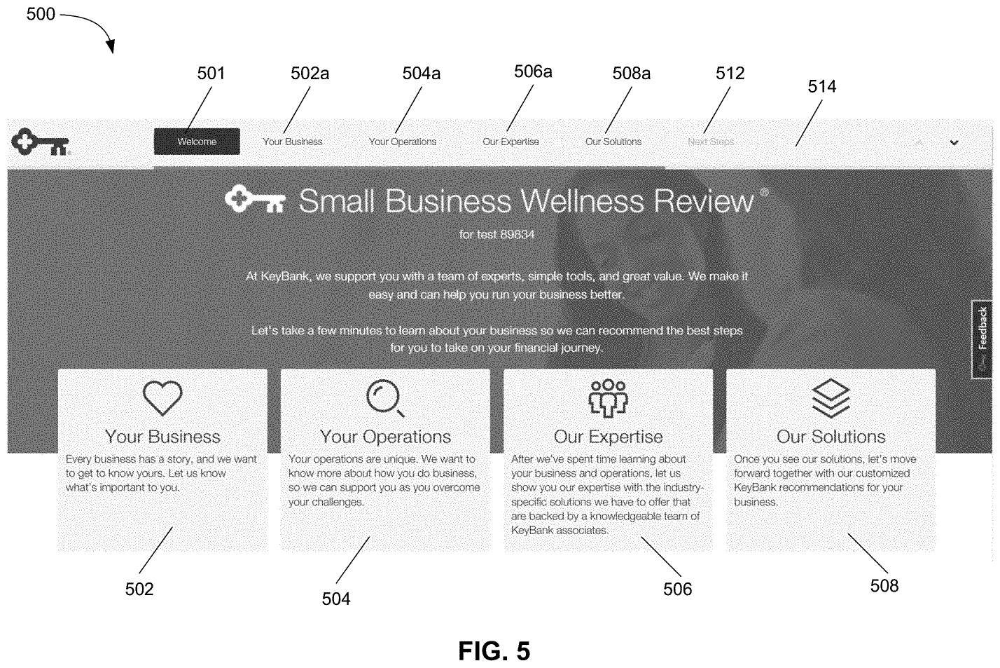

FIG. 5 illustrates a screenshot 500 of a welcome page (which is shown by the highlighted link 501) for the wellness review tool. In the illustrated embodiment, the screenshot 500 includes four features (502, 504, 506, 508) of the wellness review tool. These four features (502, 504, 506, 508) may include links that direct the user to a page(s) that correspond to the selected feature, for example the text shown may be a link (by click or touch). The first feature 502 (labeled “Your Business”) corresponds to the client's business and also includes link 502a that will direct the user to one or more pages with questions regarding the client's business. The second feature 504 (labeled “Your Operations”) corresponds to the operation of the client's business and include link 504a that will direct the user to one or more pages with questions regarding the operation of the client's business. The third feature 506 (labeled “Our Expertise”) corresponds to the business consultant's expertise and includes link 506a that will direct the user to one or more pages with information relating to the business consultant's expertise. The fourth feature 508 (labeled “Our Solutions”) corresponds to solutions that the business consultant provides to the business owner and includes link 508a that will direct the user to solutions provided by the business consultant. While each of the features (502, 504, 506, 508) are shown as having two links, it should be understood that each feature can have one or more links that directs a user to the desired pages. In addition, while the illustrated embodiment shows the wellness review tool having four features, it should be understood that the wellness review tool can include any number of features that allow a business consultant to obtain information about a client's business and provide expertise and solutions to the client. In some embodiments, the screenshot 500 includes another feature (labeled “Next Steps”) that provides a client with next steps to take after going through the four main features (502, 504, 506, 508) of the wellness review tool. In the screenshot 500, this next steps feature is shown by link 512.

In certain embodiments, the various features (502, 504, 506, 508) must be completed in a specific order. For example, the user must first complete the first feature 502 before being able to use the second feature 504, and the user must complete the second feature 504 before completing the third feature 506, and the user must complete the third feature 506 before completing the fourth feature 508. In these embodiments, a user may not be able to click on a link for one of the features (502, 504, 506, 508) until the required prior feature is completed. In other embodiments, the user can move click the links for any of the features (502, 504, 506, 508) at any time. In some embodiments, the screenshot 500 may include a link that will automatically redirect the user to the features (502, 504, 506, 508) in a predetermined order.

In the illustrated embodiment, the links (501, 502a, 504a, 506a, 508a, 512) are disposed on a heading 514 and are configured to be highlighted when a user is on a page that corresponds to the various links so that the user recognizes which portion of the wellness review tool the user is currently using. That is, screenshot 500 shows the user on the welcome page, so the link 501 for the welcome page is highlighted, and the other links (502a, 504a, 506a, 508a, 512) are not highlighted.

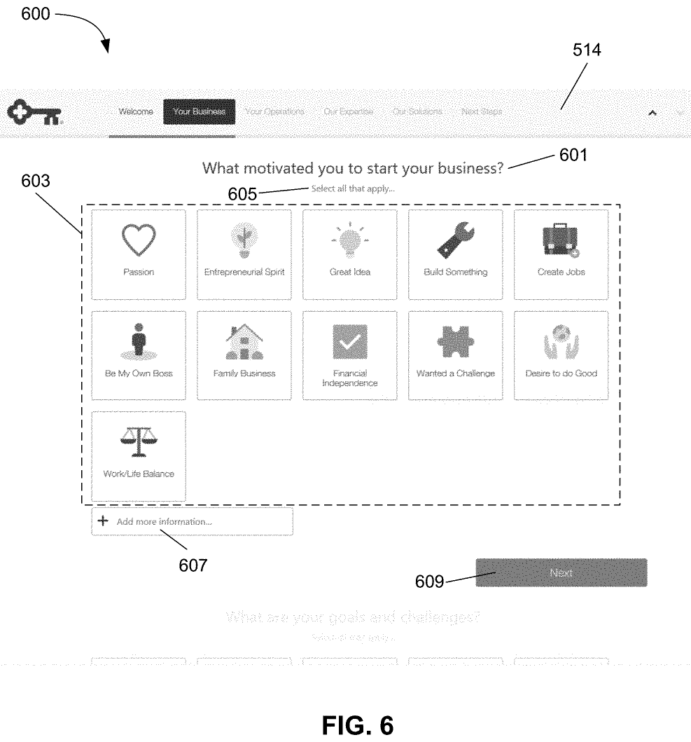

FIGS. 6-13 illustrate various screenshots for the first feature 502 of the wellness review tool. In the illustrated embodiment, the first feature 502 is labeled as “Your Business” and involves obtaining information about the client's business. The header 514 shown in FIG. 5 may be included in the screenshots for the first feature 502, but the link 502b that corresponds to the first feature 502 would be highlighted, and the other links (501, 504a, 506a, 508a, 512) would not be highlighted, which allows the user to recognize which portion of the wellness review tool the user is currently using. Regarding the first feature 502, the screenshots of FIGS. 6-13 illustrate various questions generated by the wellness review tool, and the user will provide answers to the questions regarding the client's business (which corresponds to the step 206 of the method 200 of FIG. 2). The user can be the new client or one or more business consultants that are helping the new client.

Referring to FIG. 6, a first screenshot 600 of the first feature 502 shows a first question 601 generated by the wellness review tool, which is “What motivated you to start your business?”. The first screenshot 600 lists various selection links 603 for the user to click to answer the question. The answers shown by the selection links 603 can be, for example, passion, entrepreneurial spirit, great idea, build something, create jobs, be my own boss, family business, financial independence, wanted a challenge, a desire to be good, work/life balance, or any other answer related to a client's motivation for starting a business. Also, for this question, the screenshot 600 shows that wellness review tool is configured to allow the user to “select all that apply . . . ,” as shown by reference character 605. In addition, the screenshot 600 includes an input field 607 labeled “Add more information” so that the user can add answers that are not shown by one of the selection links 603. Once the user answers the question 601, the user selects the “Next” link 609 to move onto the next question, and the processor 102 of the computing system 100 saves the answers to the first question 601 in the memory 106 of the computing device.

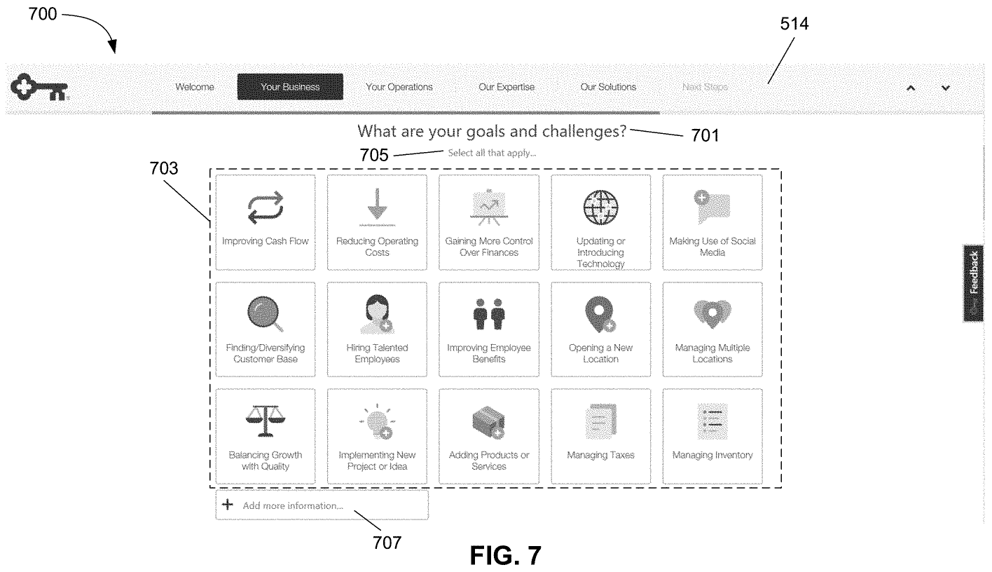

Referring to FIG. 7, a second screenshot 700 of the first feature 502 shows a second question 701 generated by the wellness review tool, which is “What are your goals and challenges?”. The second screenshot 700 lists various selection links 703 for the user to click to answer the question. The answers shown by the selection links 703 can be, for example, improving cash flow, reducing operating costs, gaining more control over finances, updating or introducing technology, making use of social media, finding/diversifying customer base, hiring talented employees, opening a new location, managing multiple locations, balancing growth with quality, implementing new projects or ideas, acquiring another business, adding products or services, understanding insurance and regulations, managing taxes, operating internationally, fraud prevention, managing inventory, or any other answer related to a client's goals and challenges with a business. Also, for this question, the screenshot 700 shows that wellness review tool is configured to allow the user to “select all that apply . . . ,” as shown by reference character 705. In addition, the screenshot 700 includes an input field 707 labeled “Add more information” so that the user can add answers that are not shown by one of the selection links 703. Once the user answers the question 701, the user can select a link (not shown) to move onto the next question, or, alternatively, scroll down to further questions, and the processor 102 of the computing system 100 may save the answers to the second question 701 in the memory 106 of the computing device.

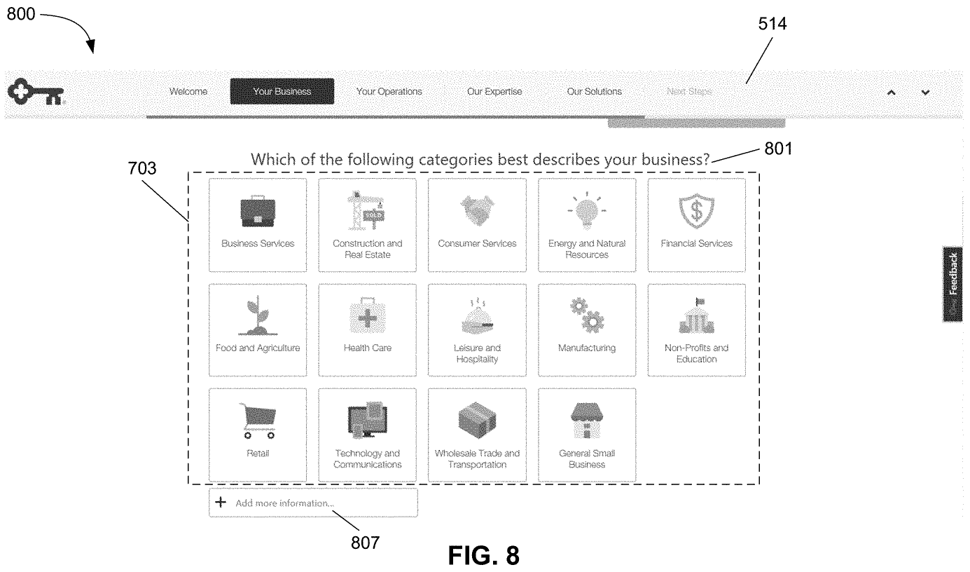

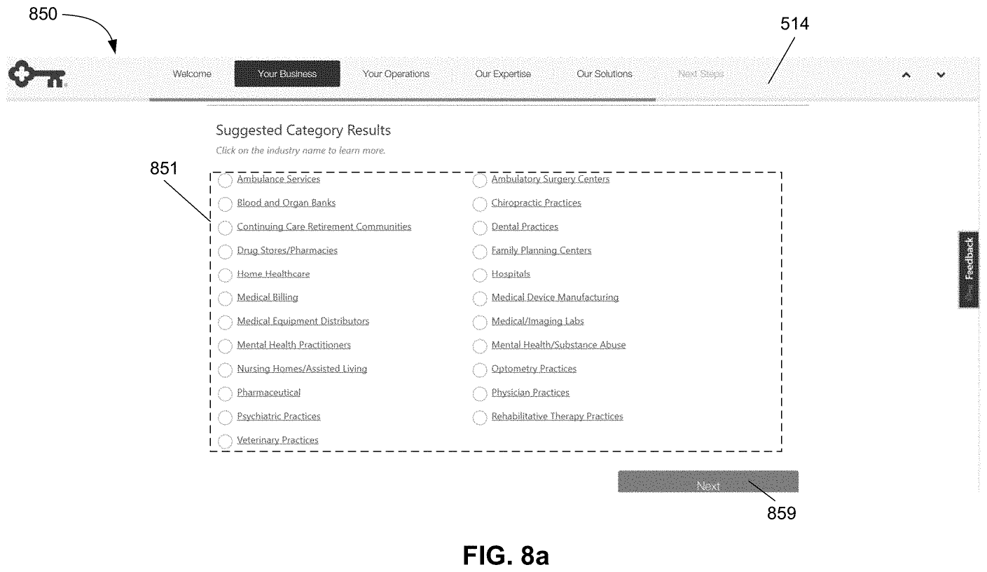

Referring to FIG. 8, a third screenshot 800 of the first feature 502 shows a third question 801 generated by the wellness review tool, which is “Which of the following best describes your business?”. The third screenshot 800 lists various selection links 803 for the user to click to answer the question. The answers shown by the selection links 803 can be, for example, food and agriculture; forestry; fishing; automotive; consumer services, technology and communications; publishing; construction and real estate; education; energy and natural resources; financial services; insurance; healthcare; leisure and hospitality; household services; manufacturing; mining; non-profit and public administration; business services; professional services; restaurants, clubs, and bars; retail; transportation and utilities; wholesale trade and import/export; general small business; or any other answer related to a description of the client's business. The screenshot 800 does not include a “select all that apply” instruction, so the user can only select a single answer to the question 801. In other embodiments, the wellness review tool will allow the user to select all that apply to question 801. The screenshot 800 also includes an input field 807 labeled “Add more information” so that the user can select an answer that is not shown by one of the selection links 803. Once the user answers the question 801, the user can select a link (not shown) to move onto the next question, or, alternatively, scroll down to further questions, and the processor 102 of the computing system 100 may save the answers to the second question 801 in the memory 106 of the computing device.

Referring to FIG. 8a, an industry drilldown screen 850 allows a user to provide more specific information about the client's business. For example, in the screenshot 850, a user has selected “healthcare” on prior screen 800, so the industry drilldown screen 850 provides a number of specific selectable business types 851 within the healthcare industry. In some embodiments a user must chose a best match to move forward in the review tool. Once the user has select a more specific business type (if applicable), the user selects the “Next” link 859 to move onto the next question, and the processor 102 of the computing system 100 saves the answers to the first question 851 in the memory 106 of the computing device.

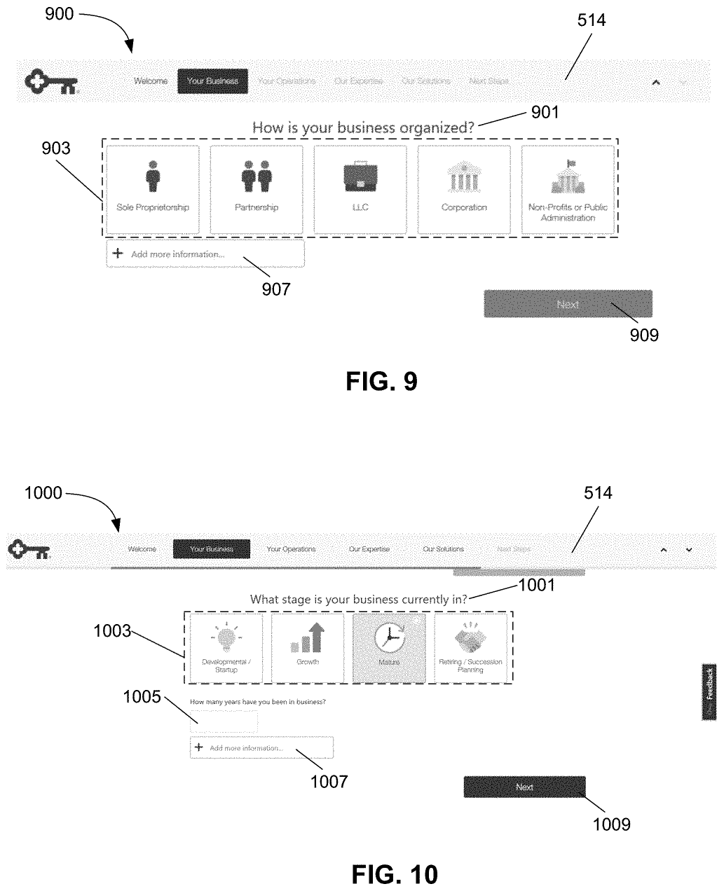

Referring to FIG. 9, a fourth screenshot 900 of the first feature 502 shows a fourth question 901 generated by the wellness review tool, which is “How is your business organized?”. The fourth screenshot 900 lists various selection links 903 for the user to click to answer the question. The answers shown by the selection links 903 can be, for example, sole proprietorship, partnership, LLC, corporation, non-profit or public administration, or any other answer related to the organization of the client's business. The screenshot 900 does not include a “select all that apply” instruction, so the user can only select a single answer to the question 901. The screenshot 900 also includes an input field 907 labeled “Add more information” so that the user can select an answer that is not shown by one of the selection links 903. Once the user answers the question 901, the user selects the “Next” link 909 to move onto the next question, and the processor 102 of the computing system 100 saves the answer to the fourth question 901 in the memory 106 of the computing device.

Referring to FIG. 10, a fifth screenshot 1000 of the first feature 502 shows a fifth question 1001 generated by the wellness review tool, which is “What stage is your business currently in?”. The fifth screenshot 1000 lists various selection links 1003 for the user to click to answer the question. The answers shown by the selection links 1003 can be, for example, Development/Startup, Growth, Mature or Retiring/Succession planning. The screen 1000 also includes a text box 1005 for a user to enter the amount of time that the business has been active. The screenshot 1000 does not include a “select all that apply” instruction, so the user can only select a single answer to the question 1001. The screenshot 1000 also includes an input field 1007 labeled “Add more information” so that the user can select an answer that is not shown by one of the selection links 1003. Once the user answers the question 1001, the user selects the “Next” link 1009 to move onto the next question, and the processor 102 of the computing system 100 saves the answer to the fifth question 1001 in the memory 106 of the computing device.

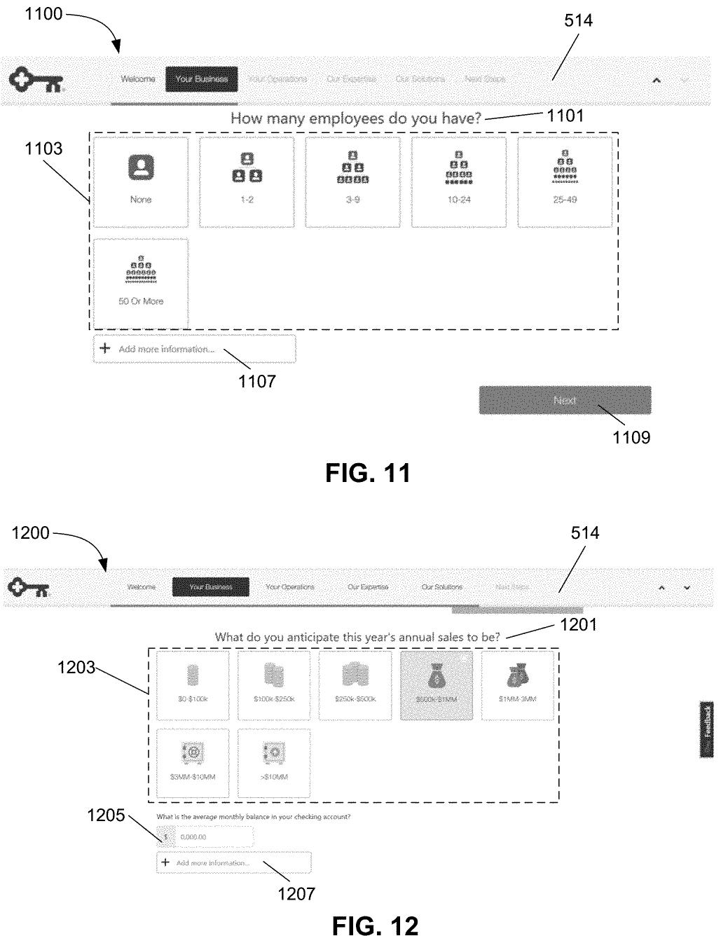

Referring to FIG. 11, a sixth screenshot 1100 of the first feature 502 shows a sixth question 1101 generated by the wellness review tool, which is “How many employees do you have?”. The sixth screenshot 1100 lists various selection links 1103 for the user to click to answer the question. The answers shown by the selection links 1103 can be, for example, none, 1-2, 3-9, 10-24, 25-49, 50 or more, or any other answer related to the amount of employees of the business. The screenshot 1100 does not include a “select all that apply” instruction, so the user can only select a single answer to the question 1101. The screenshot 1100 also includes an input field 1107 labeled “Add more information” so that the user can select an answer that is not shown by one of the selection links 1103. Once the user answers the question 1101, the user selects the “Next” link 1109 to move onto the next question, and the processor 102 of the computing system 100 saves the answer to the sixth question 1101 in the memory 106 of the computing device.

Referring to FIG. 12, a seventh screenshot 1200 of the first feature 502 shows a seventh question 1201 generated by the wellness review tool, which is “What do you anticipate this year's annual sales to be?”. The seventh screenshot 1200 lists various selection links 1203 for the user to click to answer the question. The answers shown by the selection links 1203 can be, for example, $0-$100k, $100k-$250k, $250k-$500k, $500k-$1MM, $1MM-$3MM, $3MM-$10MM, greater than $10MM, or any other answer related to the anticipated sales of the business. The screenshot 1200 does not include a “select all that apply” instruction, so the user can only select a single answer to the question 1201. The screenshot 1200 further includes a text box 1205 that allows a user to enter an average monthly balance for the client's checking account. The screenshot 1200 also includes an input field 1207 labeled “Add more information” so that the user can select an answer that is not shown by one of the selection links 1203. Once the user answers the question 1201, the user can select a link (not shown) to move onto the next question, or, alternatively, scroll down to further questions, and the processor 102 of the computing system 100 may save the answers to the second question 1201 in the memory 106 of the computing device.

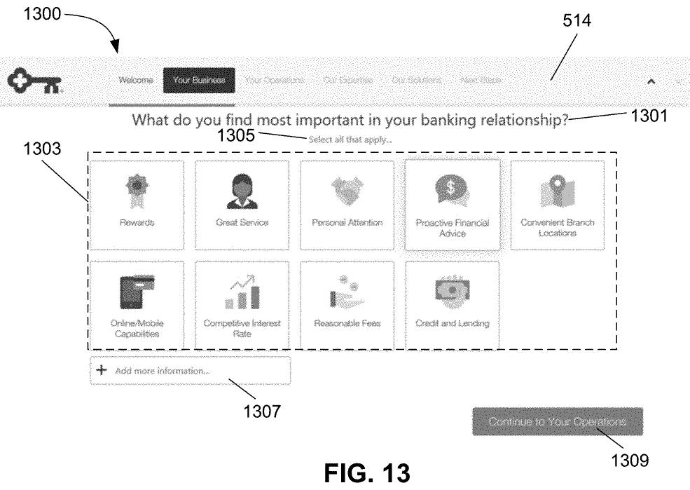

Referring to FIG. 13, an eighth screenshot 1300 of the first feature 502 shows a eighth question 1301 generated by the wellness review tool, which is “What do you find most important in your banking relationship?”. The eighth screenshot 1300 lists various selection links 1303 for the user to click to answer the question. The answers shown by the selection links 1303 can be, for example, rewards, great service, personal attention, proactive financial advice, convenient branch locations, online/mobile capabilities, competitive interest rate, reasonable fees, credit and lending, or any other answer related to a what the client finds important about a banking relationship. Also, for this question, the screenshot 1300 shows that wellness review tool is configured to allow the user to “select all that apply . . . ,” as shown by reference character 1305. In addition, the screenshot 1300 includes an input field 1307 labeled “Add more information” so that the user can add answers that are not shown by one of the selection links 1303. Once the user answers the question 1301, the user selects the “Continue to Next Feature” link 1309 to move onto the second feature 504, and the processor 102 of the computing system 100 saves the answers to the eighth question 1301 in the memory 106 of the computing device.

When a user moves from the first feature 502 to the second feature 504, the processor 102 of the computing device 100 has stored the answers to all of the questions for the first feature 502 in the memory 106, such that the processor can utilize the answers in other features of the wellness review tool. While the first feature 502, in the illustrated embodiment, includes eight questions regarding the client's business, it should be understood that first feature 502 can include any suitable number of questions regarding the client's business.

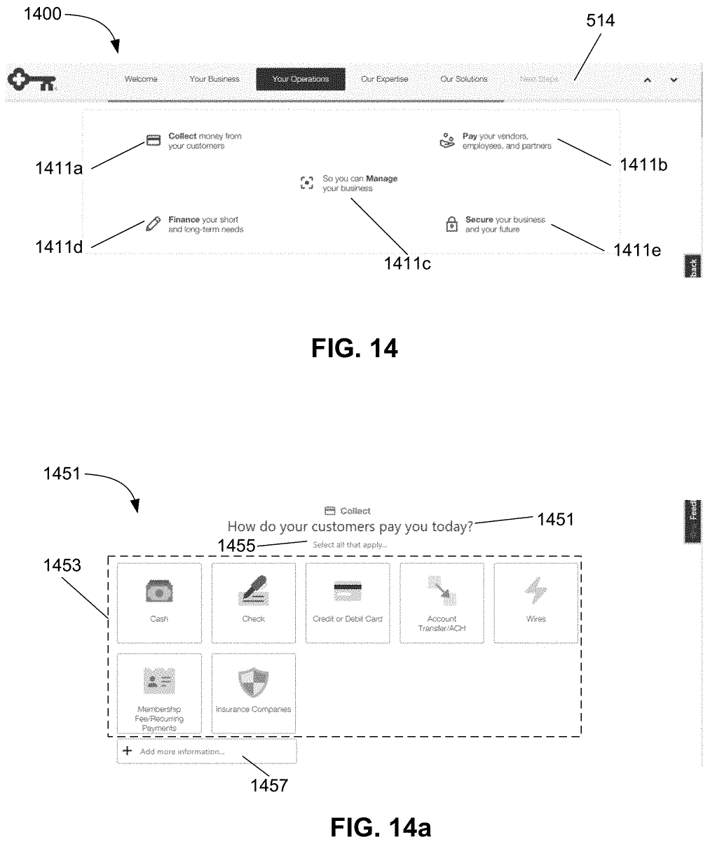

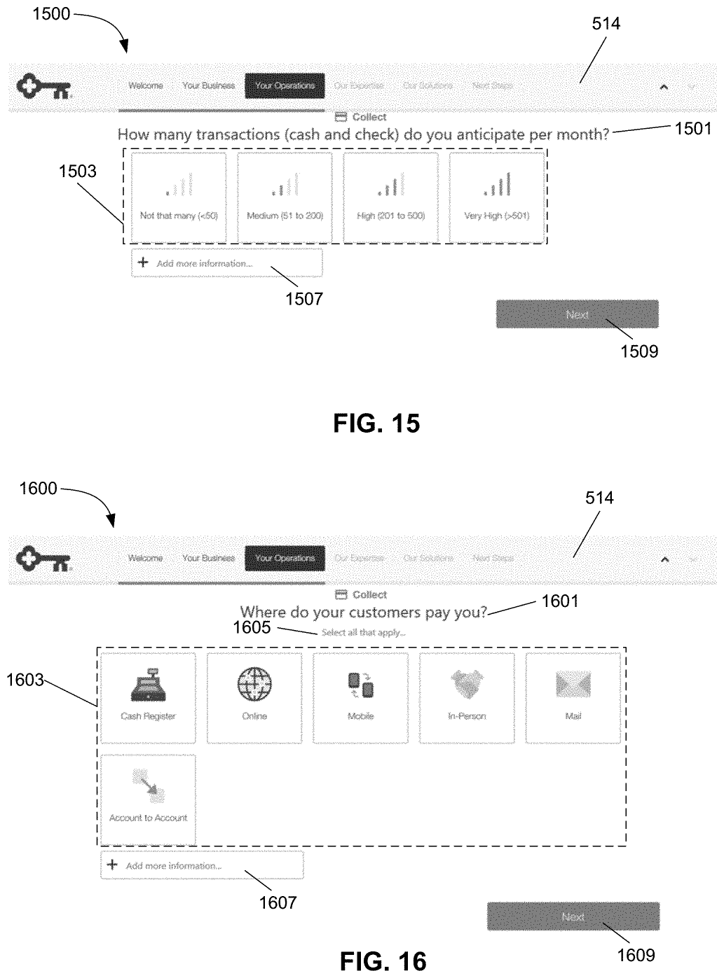

FIGS. 14-26 illustrate various screenshots for the second feature 504 of the wellness review tool. In the illustrated embodiment, the second feature 504 is labeled as “Your Operations” and involves obtaining information about the operation of the client's business. The header 514 shown in FIGS. 5-13 is included in the screenshots for the second feature 504, but the link that corresponds to the second feature 504 is highlighted, and the other links are not highlighted, which allows the user to recognize which portion of the wellness review tool the user is currently using. Regarding the second feature 504, the screenshot 1400 shown in FIG. 14 shows various sections 1411a-1411e that the questions of the second feature are divided into. In the illustrated embodiment, referring to screenshot 1400, the first section 1411a refers to the collection of money from customers; the second section 1411b refers to the paying of vendors, employees, and partners; the third section 1411c refers to the management of the business, the fourth section 1411d refers to the financing of short- and long-term needs, and the fifth section 1411e refers to securing the business for the future. It should be understood, however, that the questions of the second feature 504 can be divided into any number suitable number of sections or no sections. FIGS. 15-26 illustrate various questions generated by the wellness review tool (in which there are some questions for each section 1411a-1411e), and the user will provide answers to the questions regarding the operation of the client's business (which corresponds to the step 208 of the method 200 of FIG. 2). The user can be the new client or one or more business consultants that are helping the new client.

Referring to FIG. 14a, a first screenshot 1450 of the second feature 504 (and the first section 1411a relating to collection of money from customers) shows a first question 1501 of the second feature 504 that is generated by the wellness review tool, which is “How do your customers pay you today?”. The first screenshot 1450 lists various selection links 1453 for the user to click to answer the question. The answers shown by the selection links 1453 can be, for example, cash, check, credit or debit card, account transfer/ACH, wires, membership fee/recurring payments and insurance companies. Also, for this question, the screenshot 1450 shows that wellness review tool is configured to allow the user to “select all that apply . . . ,” as shown by reference character 1455. The screenshot 1450 also includes an input field 1457 labeled “Add more information” so that the user can select an answer that is not shown by one of the selection links 1453. Once the user answers the question 1451, the user can select a link (not shown) to move onto the next question, or, alternatively, scroll down to further questions, and the processor 102 of the computing system 100 may save the answers to the second question 1451 in the memory 106 of the computing device.

Referring to FIG. 15, a second screenshot 1500 of the second feature 504 (and the first section 1411a relating to collection of money from customers) shows a first question 1501 of the second feature 504 that is generated by the wellness review tool, which is “How many transactions (cash and check) do you anticipate per month?”. The first screenshot 1500 lists various selection links 1503 for the user to click to answer the question. The answers shown by the selection links 1503 can be, for example, less than 50, 51-200, 201-500, 501 or more, or any other answer related to the anticipated amount of transactions per month. The screenshot 1500 does not include a “select all that apply” instruction, so the user can only select a single answer to the question 1501. The screenshot 1500 also includes an input field 1507 labeled “Add more information” so that the user can select an answer that is not shown by one of the selection links 1503. Once the user answers the question 1501, the user selects the “Next” link 1609 to move onto the next question, and the processor 102 of the computing system 100 saves the answer to the first question 1501 in the memory 106 of the computing device.

Referring to FIG. 16, a third screenshot 1600 of the second feature 504 (and the first section 1411a relating to collection of money from customers) shows a second question 1601 of the second feature 504 that is generated by the wellness review tool, which is “Where do your customers pay you?”. The second screenshot 1600 lists various selection links 1603 for the user to click to answer the question. The answers shown by the selection links 1603 can be, for example, cash register, online, mobile, in-person, mail, account to account, or any other answer related to how the customers pay the business. Also, for this question, the screenshot 1600 shows that wellness review tool is configured to allow the user to “select all that apply . . . ,” as shown by reference character 1605. The screenshot 1600 also includes an input field 1607 labeled “Add more information” so that the user can select an answer that is not shown by one of the selection links 1603. Once the user answers the question 1601, the user selects the “Next” link 1609 to move onto the next question, and the processor 102 of the computing system 100 saves the answer to the second question 1601 in the memory 106 of the computing device.

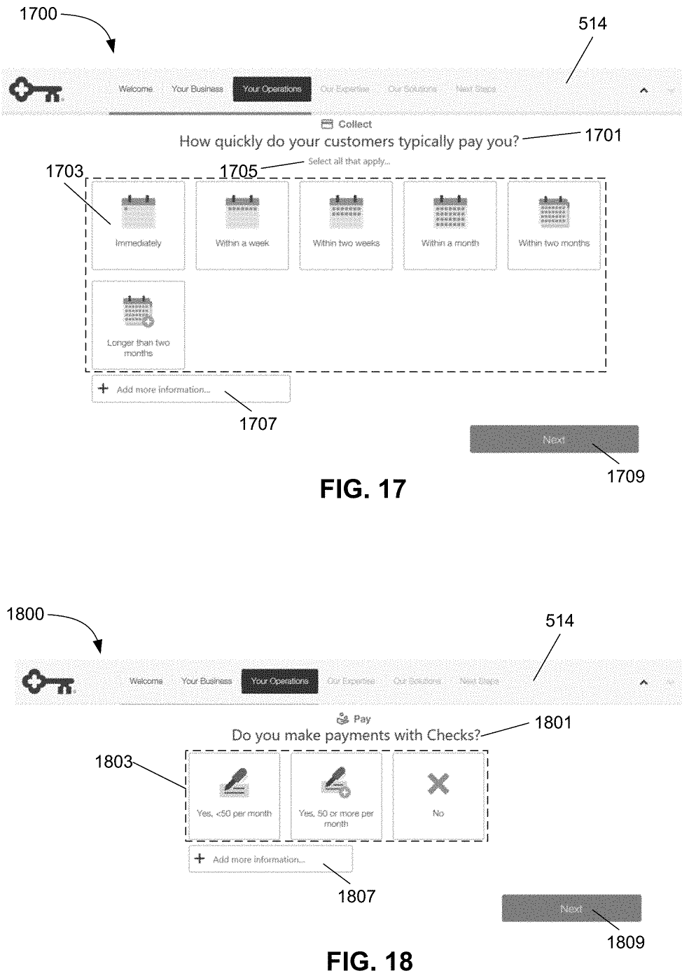

Referring to FIG. 17, a fourth screenshot 1700 of the second feature 504 (and the first section 1411a relating to collection of money from customers) shows a third question 1701 of the second feature 504 that is generated by the wellness review tool, which is “How quickly do your customers pay you?”. The third screenshot 1700 lists various selection links 1703 for the user to click to answer the question. The answers shown by the selection links 1703 can be, for example, immediately, within a week, within two weeks, within a month, within two months, longer than two months, or any other answer related to how quickly the customers pay the business. Also, for this question, the screenshot 1700 shows that wellness review tool is configured to allow the user to “select all that apply . . . ,” as shown by reference character 1705. The screenshot 1700 also includes an input field 1707 labeled “Add more information” so that the user can select an answer that is not shown by one of the selection links 1703. Once the user answers the question 1701, the user selects the “Next” link 1709 to move onto the next question, and the processor 102 of the computing system 100 saves the answer to the third question 1701 in the memory 106 of the computing device.

Referring to FIG. 18, a fifth screenshot 1800 of the second feature 504 (and the second section 1411b relating to payments) shows a fourth question 1801 of the second feature 504 that is generated by the wellness review tool, which is “Do you make payments with checks?”. The fourth screenshot 1800 lists various selection links 1803 for the user to click to answer the question. The answers shown by the selection links 1803 can be, for example, yes (less than 50 per month), yes (50 or more per month), no, or any other answer related to the business's payment with checks. The screenshot 1800 does not include a “select all that apply” instruction, so the user can only select a single answer to the question 1801. The screenshot 1800 also includes an input field 1807 labeled “Add more information” so that the user can select an answer that is not shown by one of the selection links 1803. Once the user answers the question 1801, the user selects the “Next” link 1809 to move onto the next question, and the processor 102 of the computing system 100 saves the answer to the fourth question 1801 in the memory 106 of the computing device.

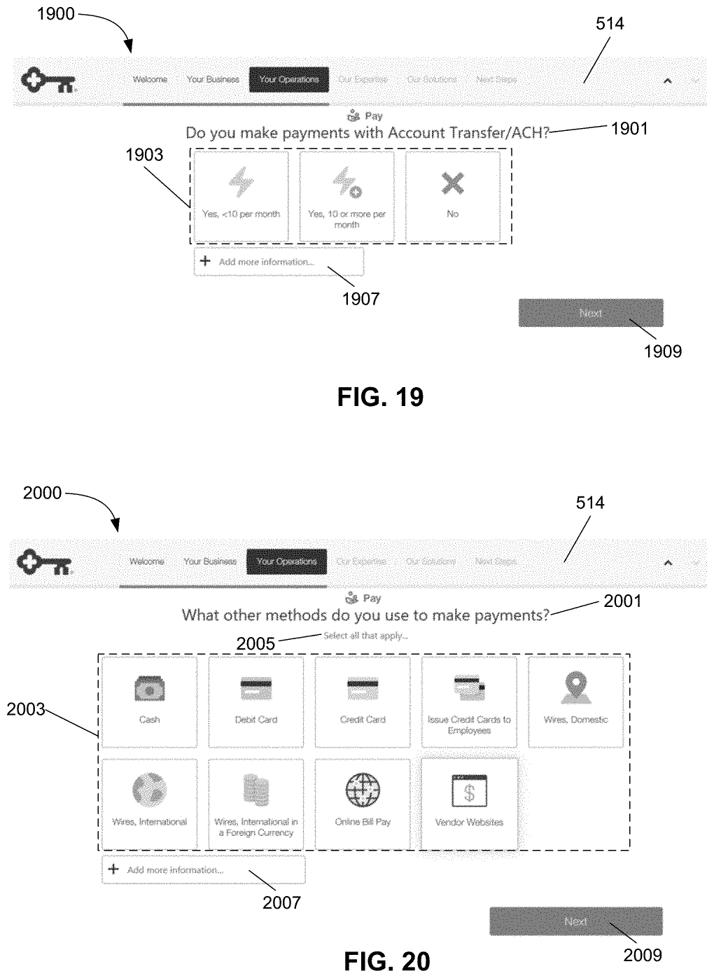

Referring to FIG. 19, a sixth screenshot 1900 of the second feature 504 (and the second section 1411b relating to payments) shows a fifth question 1901 of the second feature 504 that is generated by the wellness review tool, which is “Do you make payments with Account Transfer/ACH?”. The fifth screenshot 1900 lists various selection links 1903 for the user to click to answer the question. The answers shown by the selection links 1903 can be, for example, yes (less than 10 per month), yes (10 or more per month), no, or any other answer related to the business's payment with account transfers/ACH. The screenshot 1900 does not include a “select all that apply” instruction, so the user can only select a single answer to the question 1901. The screenshot 1900 also includes an input field 1907 labeled “Add more information” so that the user can select an answer that is not shown by one of the selection links 1903. Once the user answers the question 1901, the user selects the “Next” link 1909 to move onto the next question, and the processor 102 of the computing system 100 saves the answer to the fifth question 1901 in the memory 106 of the computing device.

Referring to FIG. 20, a seventh screenshot 2000 of the second feature 504 (and the second section 1411b relating to payments) shows a sixth question 2001 of the second feature 504 that is generated by the wellness review tool, which is “What other methods do you use to make payments?”. The sixth screenshot 2000 lists various selection links 2003 for the user to click to answer the question. The answers shown by the selection links 2003 can be, for example, cash, debit card, credit card, issued credit cards to employees, wires (domestic), wire (international), wires (international in a foreign country), online bill pay, vendor websites, or any other answer related to how the business makes payments. Also, for this question, the screenshot 2000 shows that wellness review tool is configured to allow the user to “select all that apply . . . ,” as shown by reference character 2005. The screenshot 2000 also includes an input field 2007 labeled “Add more information” so that the user can select an answer that is not shown by one of the selection links 2003. Once the user answers the question 2001, the user selects the “Next” link 2009 to move onto the next question, and the processor 102 of the computing system 100 saves the answer to the sixth question 2001 in the memory 106 of the computing device.

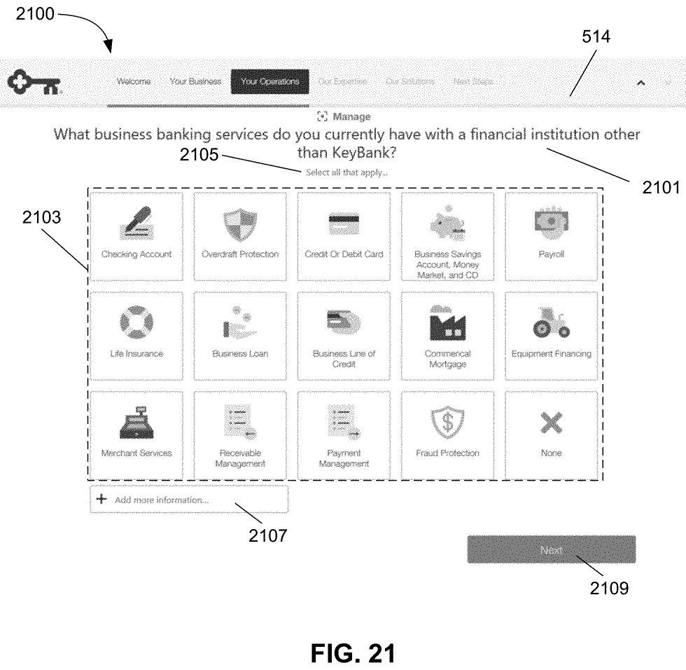

Referring to FIG. 21, an eighth screenshot 2100 of the second feature 504 (and the third section 1411c relating to management of the business) shows a seventh question 2101 of the second feature 504 that is generated by the wellness review tool, which is “What business banking services do you currently have with a financial institution other than the business consultant?”. The seventh screenshot 2100 lists various selection links 2103 for the user to click to answer the question. The answers shown by the selection links 2103 can be, for example, checking account, overdraft protection, credit or debit card, business savings account, money market account, CD, payroll, life insurance, business loan, business line of credit, commercial mortgage, equipment financing, merchant services, receivable management, payment management, fraud protection, none, or any other answer related to banking services the business has with financial institutions other than the business consultant. The screenshot 2100 does not include a “select all that apply” instruction, so the user can only select a single answer to the question 2101. The screenshot 2100 also includes an input field 2107 labeled “Add more information” so that the user can select an answer that is not shown by one of the selection links 2103. Once the user answers the question 2101, the user selects the “Next” link 2109 to move onto the next question, and the processor 102 of the computing system 100 saves the answer to the seventh question 2101 in the memory 106 of the computing device.

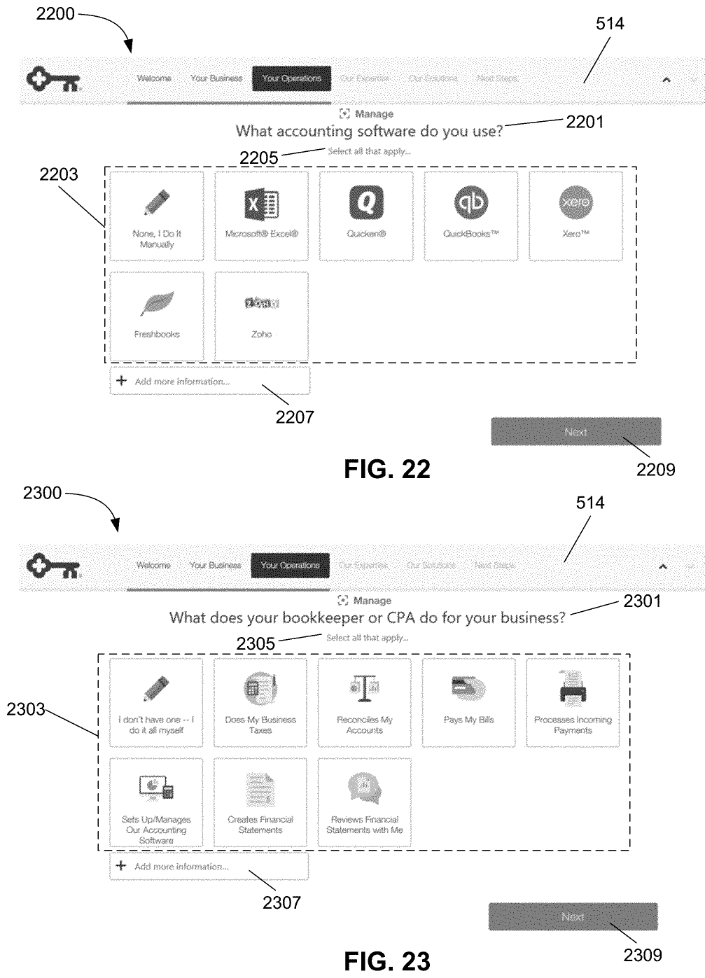

Referring to FIG. 22, an ninth screenshot 2200 of the second feature 504 (and the third section 1411c relating to management of the business) shows an eighth question 2201 of the second feature 504 that is generated by the wellness review tool, which is “What accounting software do you use?”. The eighth screenshot 2200 lists various selection links 2203 for the user to click to answer the question. The answers shown by the selection links 2203 can be, for example, none, Microsoft® Excel®, Quicken®, QuickBooks™, Xero™, Freshbooks, Zoho, or any other answer related to accounting software used by the business. Also, for this question, the screenshot 2200 shows that wellness review tool is configured to allow the user to “select all that apply . . . ,” as shown by reference character 2205. The screenshot 2200 also includes an input field 2207 labeled “Add more information” so that the user can select an answer that is not shown by one of the selection links 2203. Once the user answers the question 2201, the user selects the “Next” link 2209 to move onto the next question, and the processor 102 of the computing system 100 saves the answer to the eighth question 2201 in the memory 106 of the computing device.

Referring to FIG. 23, an tenth screenshot 2300 of the second feature 504 (and the third section 1411c relating to management of the business) shows an ninth question 2301 of the second feature 504 that is generated by the wellness review tool, which is “What does your bookkeeper or CPA do for your business?”. The ninth screenshot 2300 lists various selection links 2303 for the user to click to answer the question. The answers shown by the selection links 2303 can be, for example, I don't have one, business taxes, reconciles my accounts, pays bills, processes incoming payments, sets up and/or manages accounting software, creates financial statements, reviews financial statements, or any other answer related to the bookkeeper or CPA for the business. Also, for this question, the screenshot 2300 shows that wellness review tool is configured to allow the user to “select all that apply . . . ,” as shown by reference character 2305. The screenshot 2300 also includes an input field 2307 labeled “Add more information” so that the user can select an answer that is not shown by one of the selection links 2303. Once the user answers the question 2301, the user selects the “Next” link 2309 to move onto the next question, and the processor 102 of the computing system 100 saves the answer to the ninth question 2301 in the memory 106 of the computing device.

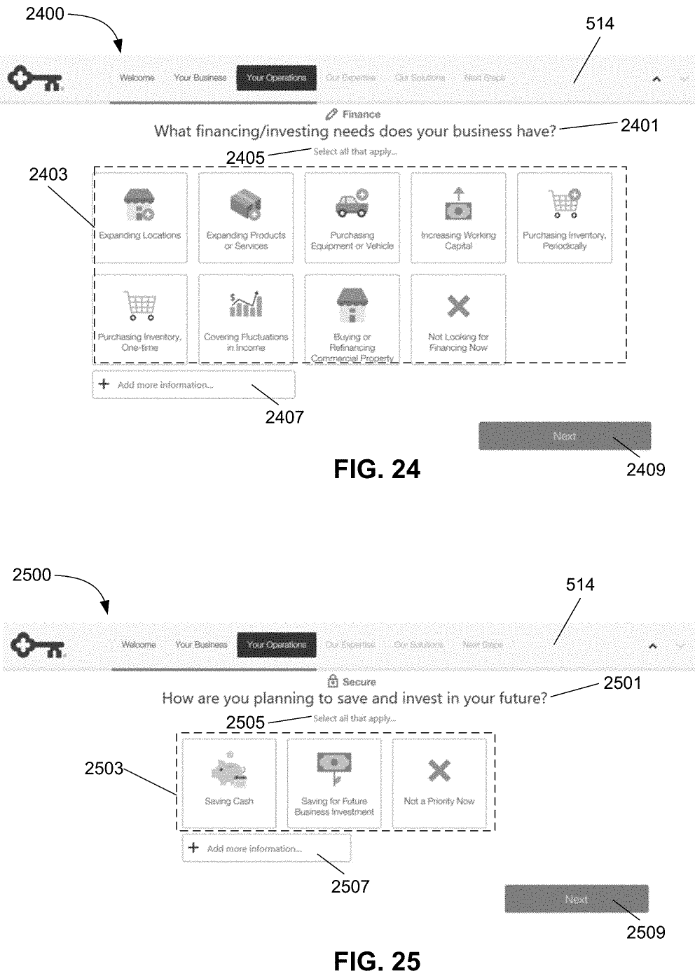

Referring to FIG. 24, an eleventh screenshot 2400 of the second feature 504 (and the fourth section 1411d relating to financing for the business) shows a tenth question 2401 of the second feature 504 that is generated by the wellness review tool, which is “What financing/investing needs does your business have?”. The tenth screenshot 2400 lists various selection links 2403 for the user to click to answer the question. The answers shown by the selection links 2403 can be, for example, expanding locations, expanding products or services, purchasing equipment of vehicles, increasing working capital, purchasing inventory (periodically), purchasing inventory (one-time), covering fluctuations in income, buying or refinancing commercial property, not look for financing now, or any other answer related to the financing and/or investing needs of the business. Also, for this question, the screenshot 2400 shows that wellness review tool is configured to allow the user to “select all that apply . . . ,” as shown by reference character 2405. The screenshot 2400 also includes an input field 2407 labeled “Add more information” so that the user can select an answer that is not shown by one of the selection links 2403. Once the user answers the question 2401, the user selects the “Next” link 2409 to move onto the next question, and the processor 102 of the computing system 100 saves the answer to the tenth question 2401 in the memory 106 of the computing device.

Referring to FIG. 25, a twelfth screenshot 2500 of the second feature 504 (and the fifth section 1411e relating to securing the business for the future) shows an eleventh question 2501 of the second feature 504 that is generated by the wellness review tool, which is “What financing/investing needs does your business have?”. The eleventh screenshot 2501 lists various selection links 2503 for the user to click to answer the question. The answers shown by the selection links 2503 can be, for example, saving cash, saving for future business investment, not a priority now, or any other answer related to the business's plans for saving and investing in the future. Also, for this question, the screenshot 2500 shows that wellness review tool is configured to allow the user to “select all that apply . . . ,” as shown by reference character 2505. The screenshot 2500 also includes an input field 2507 labeled “Add more information” so that the user can select an answer that is not shown by one of the selection links 2503. Once the user answers the question 2501, the user selects the “Next” link 2509 to move onto the next question, and the processor 102 of the computing system 100 saves the answer to the eleventh question 2501 in the memory 106 of the computing device.

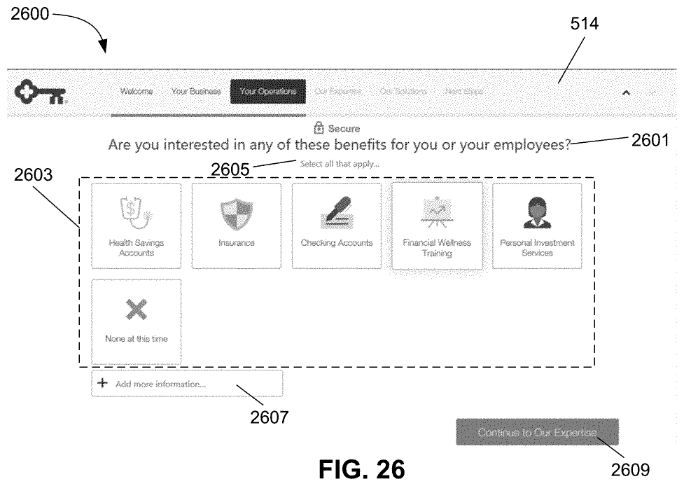

Referring to FIG. 26, a thirteenth screenshot 2600 of the second feature 504 (and the fifth section 1411e relating to securing the business for the future) shows a twelfth question 2601 of the second feature 504 that is generated by the wellness review tool, which is “Are you interested in any benefits for you or your employees?”. The twelfth screenshot 2601 lists various selection links 2603 for the user to click to answer the question. The answers shown by the selection links 2603 can be, for example, health savings accounts, insurance, checking accounts, financial wellness training, personal investment services, none at the time, or any other answer related to the business's interest in benefits for the business operator and the employees. Also, for this question, the screenshot 2600 shows that wellness review tool is configured to allow the user to “select all that apply . . . ,” as shown by reference character 2605. The screenshot 2600 also includes an input field 2607 labeled “Add more information” so that the user can select an answer that is not shown by one of the selection links 2603. Once the user answers the question 2601, the user selects the “Continue to Next Feature” link 2609 to move onto the third feature 506, and the processor 102 of the computing system 100 saves the answer to the twelfth question 2601 in the memory 106 of the computing device.

When a user moves from the second feature 504 to the third feature 506, the processor 102 of the computing device 100 has stored the answers to all of the questions for the second feature 504 in the memory 106, such that the processor can utilize the answers in other features of the wellness review tool. While the second feature 504, in the illustrated embodiment, includes thirteen questions regarding the operation of the client's business, it should be understood that second feature 504 can include any suitable number of questions regarding the client's business.

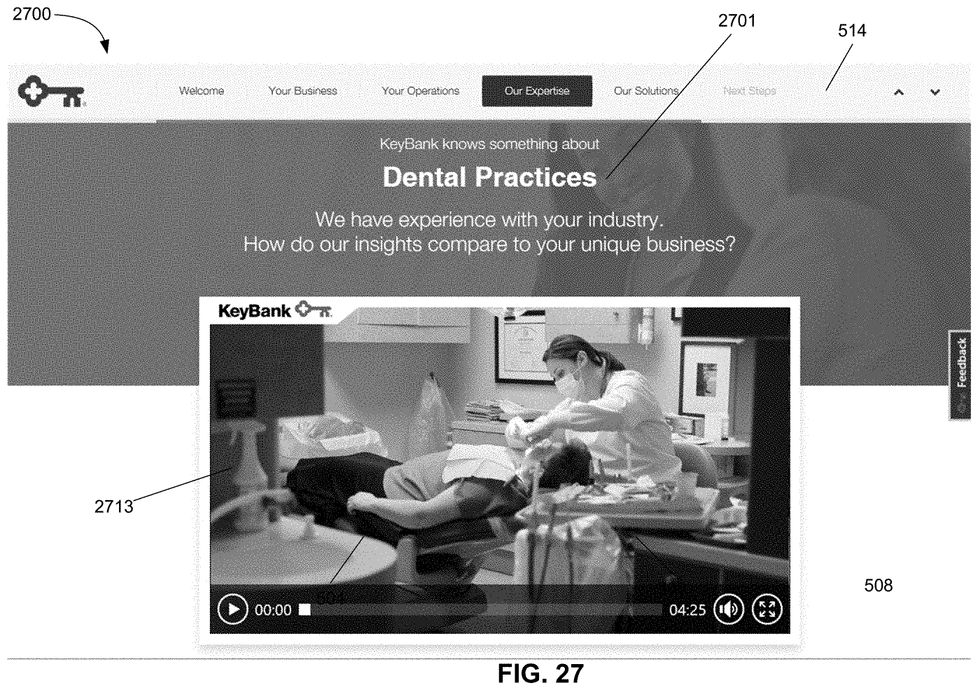

FIGS. 27-31 illustrate various screenshots for the third feature 506 of the wellness review tool. In the illustrated embodiment, the third feature 506 is labeled as “Our Expertise” and involves the wellness review tool providing industry specific information to the client based on the answers to the questions of the first and second features 502, 504, and involves the business consultant providing expert knowledge to the client based on the industry and the client's answers to the questions. Exemplary algorithms for providing this information are discussed below. The header 514 shown in FIGS. 5-26 is also included in the screenshots for the third feature 506, but the link that corresponds to the third feature 506 is highlighted, and the other links are not highlighted, which allows the user to recognize which portion of the wellness review tool the user is currently using.

The screenshots in FIGS. 27-31 illustrate industry specific information generated by the wellness review tool, which is provided to the user via the user interface 104 of the computing device 100. In addition to the display via the wellness review tool's user interface 104, the system may provide the industry specific information in a table in a separate document that printed or transmitted to the client, for example, via electronic mail.

Still referring to FIGS. 27-31, in the illustrated embodiment, the wellness review tool determined (by the processor 102 and memory 106 of the computing device 100) that the client's business is in the industry of “Dental Practices,” as shown by reference character 2701 shown in FIG. 27. While the third feature 506 will be described with reference to the “Dental Practices” industry, it should be understood that the third feature 506 can provide industry specific information for any industry in which the client' business is operating. Referring to FIG. 27, a first screenshot 2700 of the third feature 506 shows a video 2713, which may play for the user via the user interface 104. The video 2713 may explain key facts and/or statistics about the selected industry and/or explain the consultant's current engagement and expertise in that industry.

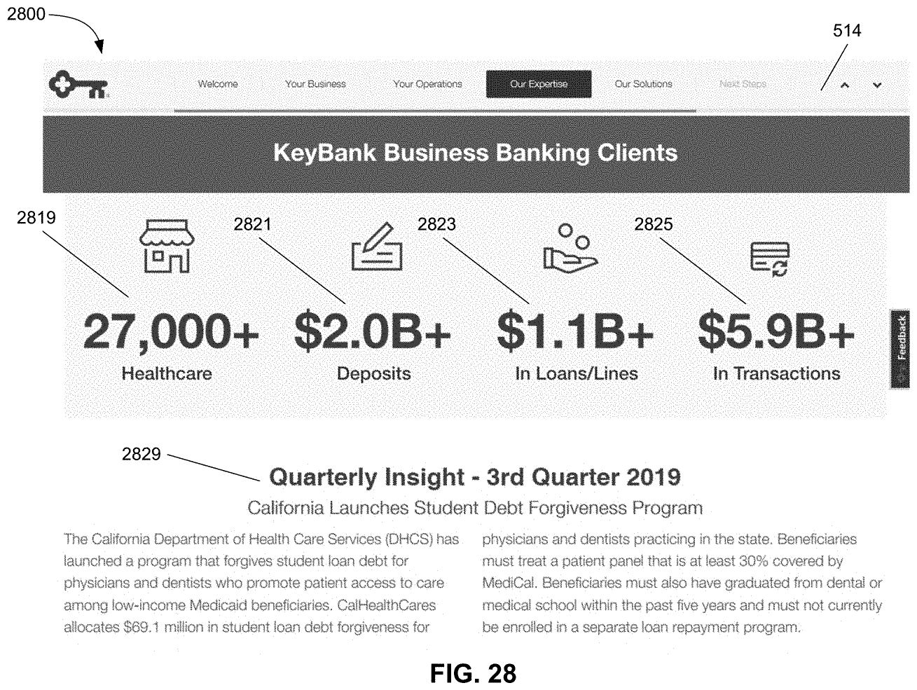

FIGS. 28-31 are exemplary screens of the wellness review tool that provide various statistics regarding the client's industry. Referring to FIG. 28, a screenshot 2800 shows statistics related to the business consultant's clients in the industry. In the illustrated embodiment, a first statistic 2819 relating to the business consultant's clients in the industry is the number of industry clients, a second statistic 2821 is the amount of money in deposits made by these industry clients, a third statistic 2823 is the amount of money in loans by these industry clients, and a fourth statistic 2825 is the amount of money in transactions made by these industry clients. Any other relevant statistic, however, about the business consultant's industry clients can be included in the screenshot 2800. The screenshot 2800 also includes a news section 2829, which may provide a recent or current article or news item relating to the industry.

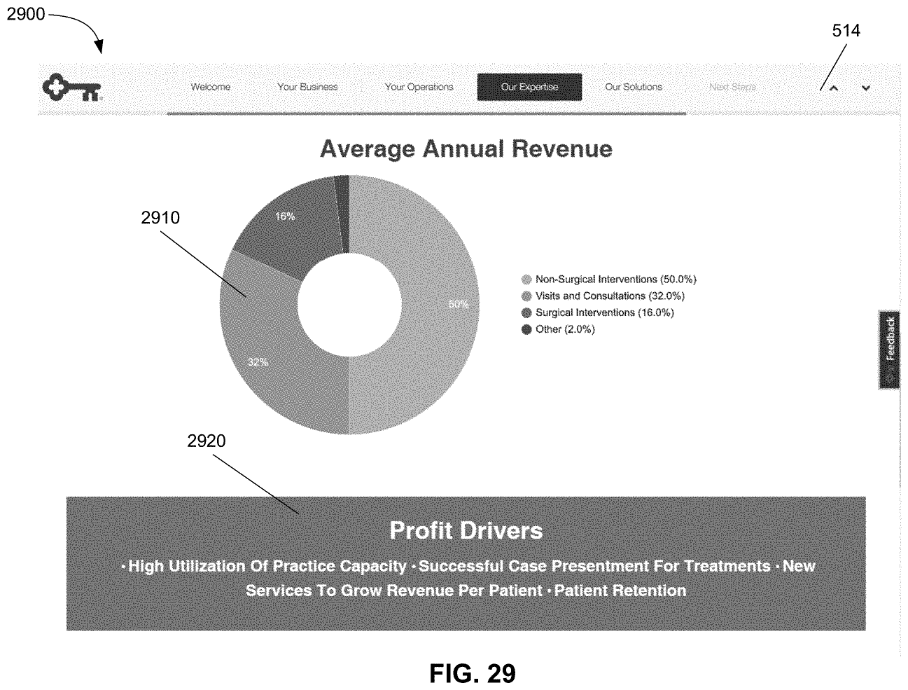

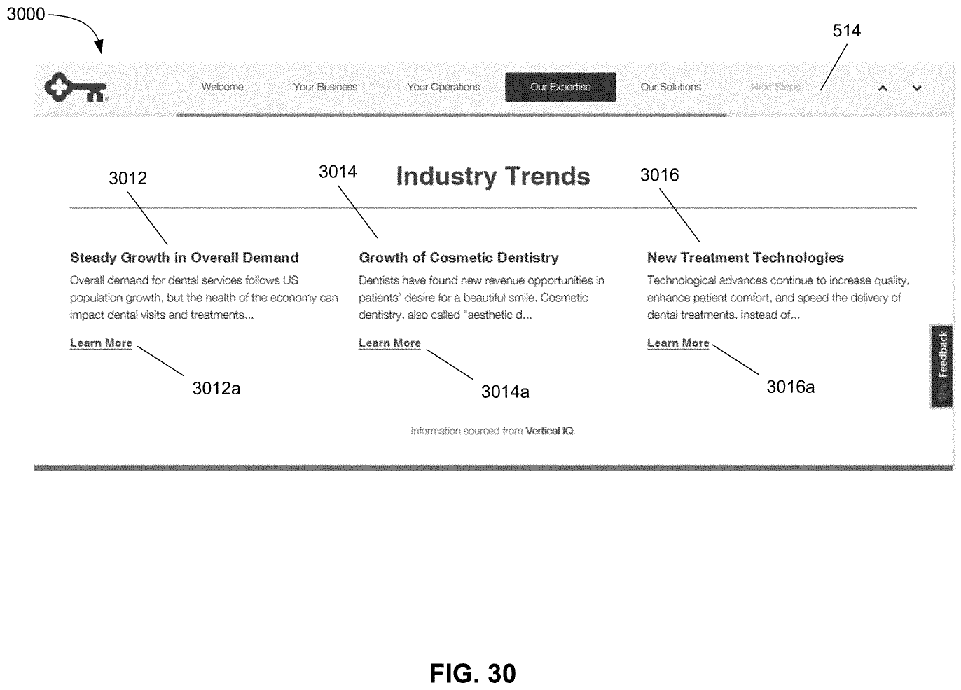

Referring to FIG. 29, a screenshot 2900 includes an infographic 2910 illustrating a breakdown average annual revenue sources for the industry. An information box 2920 provides a list of top profit driving business practices for the industry. Referring to FIG. 30, a screenshot 3000 includes a list of trends 3012, 3014 and 3016 for industry. The screenshot 3000 also include a set of corresponding links 3012a, 3014a and 3016 that cause a display of additional information regarding that trend in a popup window, additional screen or via link to an external site.

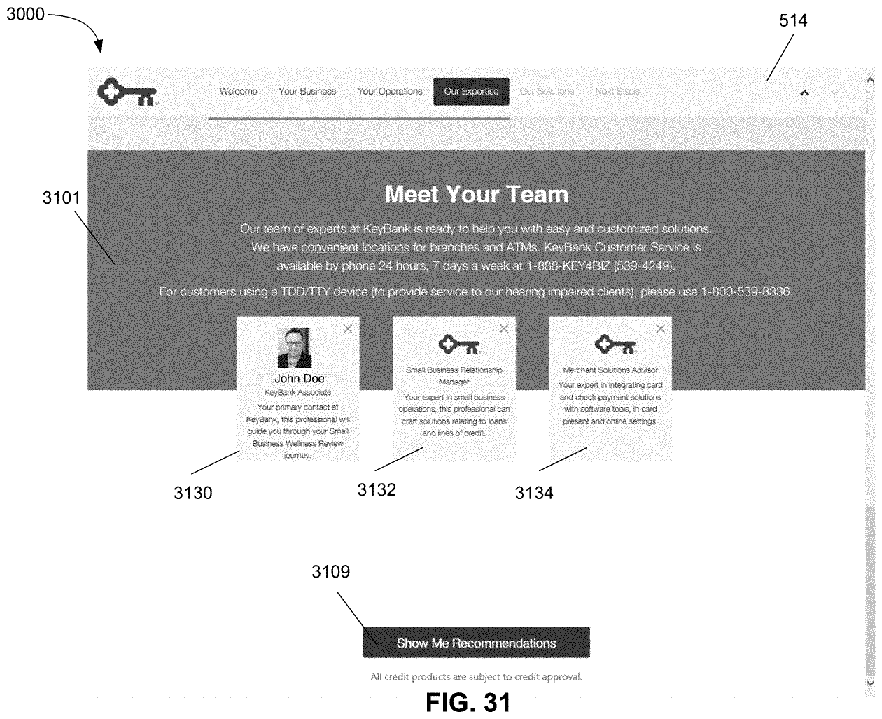

Referring to FIG. 31, the screenshot 3100 shows a team of experts 3101 of the business consultant that is provided to the client, in which the team of experts 3101 are configured to provide customized solutions to the client based on the information inputted into and provided by the wellness review tool. In the illustrated embodiment, the team of experts 3101 includes an associate 3130, a manager 3132, and an advisor 3134. The team of experts 3101, however, can include any number of experts with any type of positions. Once the user answers the question examines the industry specific information provided in the screenshots in FIGS. 27-31, the user selects the “Show Me Recommendations” link 3109 to move onto the fourth feature 508, and the processor 102 of the computing system 100 saves the information provided to the client by the wellness review tool with the third feature 506.

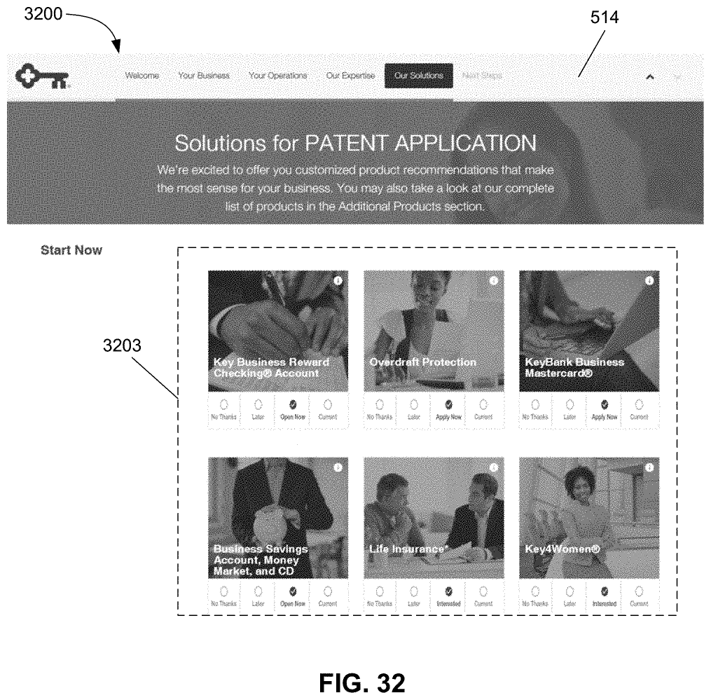

FIGS. 32-35 illustrate various screenshots for the fourth feature 508 of the wellness review tool. In the illustrated embodiment, the fourth feature 508 is labeled as “Our Solutions” and involves the wellness review tool providing solutions (e.g., products and services of the business consultant) to the client based on the answers to the questions of the first and second features 502, 504, and based on the industry specific information provided by the third feature 506. In addition, the fourth feature 508 involves the business consultant providing expert knowledge to the client based on the industry, the client's answers to the questions, and the solutions offered by the business consultant. The header 514 shown in FIGS. 5-31 is also included in the screenshots for the fourth feature 508, but the link that corresponds to the fourth feature 508 is highlighted, and the other links are not highlighted, which allows the user to recognize which portion of the wellness review tool the user is currently using.

The screenshots in FIGS. 32-35 illustrate various solutions offered by the business consultant and generated by the wellness review tool, which is provided to the user via the user interface 104 of the computing device 100. Exemplary algorithms for selecting products based on user inputs are described below. The providing of solutions by the wellness review tool corresponds to the sixth step 212 of the method 200 discussed with reference to FIG. 2.

Referring to FIG. 32, the screenshot 3200 includes various products 3203 that the client could use for the business. The products 3203 can be, for example, a checking account, overdraft protection, a credit card, a business savings account, a money market account, a CD, life insurance, a customized program for helping women business owners, or any other product that the client could use for the business. The screenshot 3200 also includes an interest selection links for each of the products 3203. The interest selection links allow the user to select the client's level of interest in each of the products 3203. In the illustrated embodiment, each of the interest selection links includes four options—(1) not interested; (2) later; (3) interested; and (4) currently have. The interest selection links 3305 can, however, take any suitable form that allows the user to select the client's interest with respect to the products 3203.

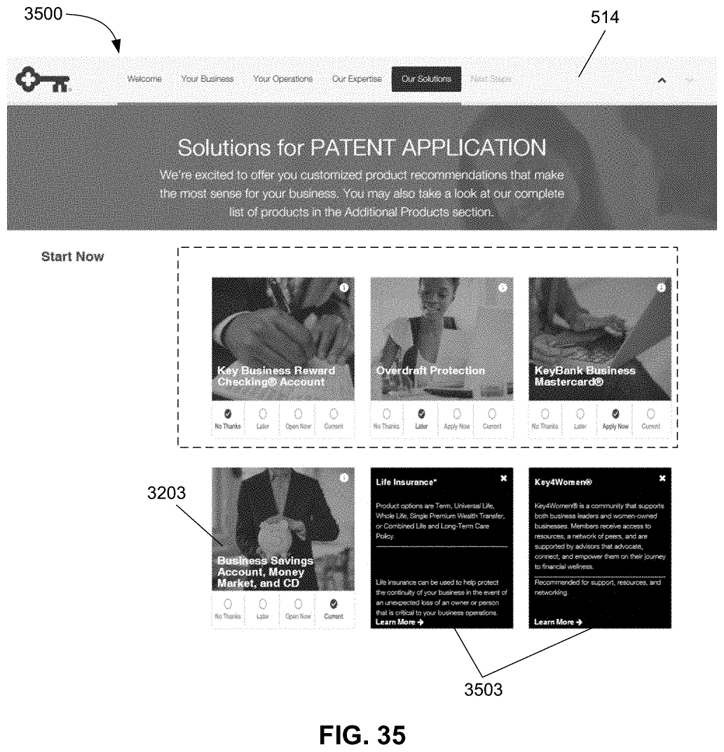

Referring to FIGS. 32 and 35, in certain embodiments, the products 3203 include links such that a user could click on the product symbol to receive information about the product. That is, screenshot 3200 shows six products 3203, and screenshot 3500 shows the same six products 3203. In screenshot 3500, however, the user clicked on the symbol for two of the products such that an information screen 3503 for those two products is shown. These links for information allow a user to learn more about the products 3203.

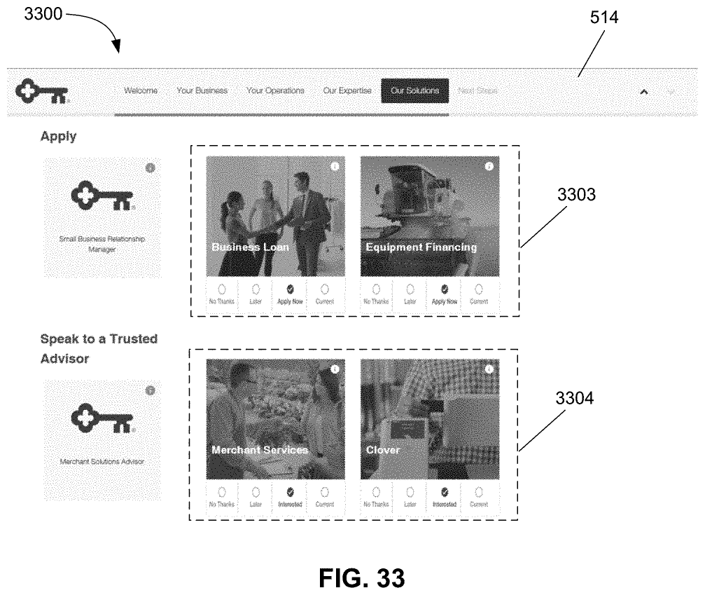

Referring to FIG. 33, the screenshot 3300 includes various loan products 3303 that the client could apply for and various services 3304 that the client could use for the business. The loan products 3303 can be, for example, a business loan, an equipment financing loan, or any other loan product that the client could use for the business. The various services 3304 can be, for example, merchant services, mobile or online application services, or any other service that the client could use for the business. The screenshot 3300 also includes an interest selection link for each of the products 3303 and interest selection link for each of the services 3304. The interest selection links allow the user to select the client's level of interest in each of the loan products 3303. In the illustrated embodiment, each of the interest selection links for the loan products 3303 includes four options—(1) not interested; (2) later; (3) apply; and (4) currently have. The interest selection links allow the user to select the client's level of interest in each of the services 3304. In the illustrated embodiment, each of the interest selection links 3306 for the loan products 3304 includes four options—(1) not interested; (2) later; (3) interested; and (4) currently have. The interest selection links can, however, take any suitable form that allows the user to select the client's interest with respect to the products 3203.

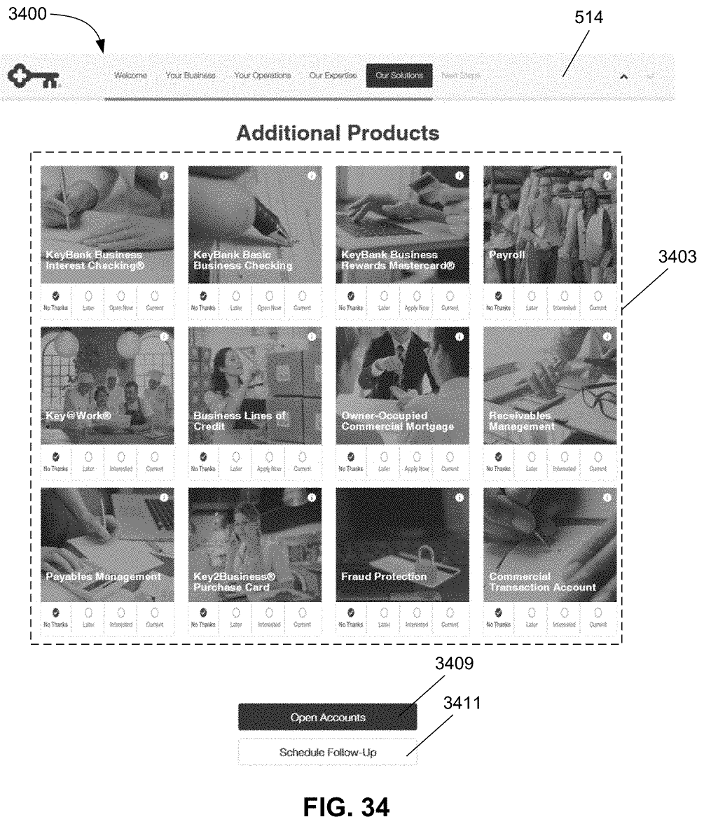

Referring to FIG. 34, the screenshot 3400 includes additional products 3403 that the client could use for the business. The products 3403 can be, for example, an interest checking account, a business checking account, a business credit card, payroll, business lines of credit, mortgages, receivables management, payables management, fraud protection, a commercial transaction account, or any other product that the client could use for the business. The screenshot 3400 also includes an interest selection links for each of the products 3403. The interest selection links allow the user to select the client's level of interest in each of the products 3403. In the illustrated embodiment, each of the interest selection links includes four options—(1) not interested; (2) later; (3) interested; and (4) currently have. The interest selection links 3405 can, however, take any suitable form that allows the user to select the client's interest with respect to the products 3403. The screenshot 3400 also includes an “Open Accounts” link 3409 and a “Schedule Follow-Up” link 3411. The “Open Accounts” link will direct the user to a portion of the wellness review tool (or a separate tool) in which the client can obtain any of the products (3203, 3303, 3403) or services (3304) discussed with reference to FIGS. 32-34. The “Schedule Follow-Up” link 3411 will allow the user to set up a follow-up meeting with the business consultant.

The product described above are the result of a complex logic based on the answers the client provides to the various questions presented via the user interface as explained above. Exemplary logic is described below. For example, a rewards checking account may be recommended if (1) the client has more than 250 transaction per month, (2) merchant services are recommended for the client or (3) the client is looking for rewards. An interest checking may be recommended if the client states they are interested in interest. A business checking account and overdraft protection may always be recommended. A business credit card may be recommended if the client is not looking for rewards. A reward credit card may always be recommended.

Further examples of product recommendation logic include that a Business Savings Account, Money Market, and CD may be recommended if (1) the client has more than $250,000 in sales, (2) the client is saving cash, (3) the client is in one of Professional Services, Real Estate, Health Care, Agricultural, Forestry & Fishing, Finance and Insurance, Retail and Restaurants, or Cafes and Bars industries, or (4) the client has such an account with another institution. Payroll may be recommended if the client more than 10 employees or has payroll with another financial institution. An employee benefits package may be recommended if the client has between 10 and 25 employees and is not in any of the General Small Business, Automotive, Hospitality and Entertainment, Household Services, Restaurants, Cafes, and Bars, and Retail industries. Life insurance may always be recommended. Key4Women®, a program that supports financial wellbeing for businesswomen may always be recommended

More examples of product recommendation logic include that a business loan may be recommended if (1) the client is looking to expand the business, (2) the client is looking to make a one-time inventory purchase, (3) the client is in one of the Agricultural, Forestry & Fishing, Manufacturing, Restaurants, Cafes and Bars, Healthcare, Retail, Real Estate industries, or (4) the client has a loan with another financial institution. A business line of credit may be recommended if the client (1) is looking to increase working capital or cover income fluctuations, (2) is looking to periodically purchase inventory, (3) is in one of the Manufacturing, Wholesale Trade, Construction, Health Care, Retail, or Professional Services industries, or (4) has a line of credit with another financial institution. A commercial mortgage may be recommended if (1) the client is looking to buy or refinance commercial property, (2) the client is in one of the Health Care, Manufacturing, Professional Services, Real Estate, Retail, Restaurants, or Cafes and Bars industries, or (3) the client has a mortgage with another financial institution. Equipment financing may be recommended if the client (1) is looking to buy equipment or a vehicle, (2) is in any of the Agricultural, Forestry & Fishing, Manufacturing, Construction, Transportation and Utilities, or Healthcare industries, or (3) has equipment financing with another lender.

Additional examples of product recommendation logic include that merchant services is recommended if (1) the client's customer's pay with credit or debit card, (2) the client's customers pay online or at a cash register, (3) the client is in any of the Professional Services, Restaurants, Cafes, and Bars, Retail, Health Care, Construction, Automotive or, Non-Profits and Public Administration industries, or (4) the client has merchant services with another institution. Receivables management is recommended if (1) the client collects payment via ACH or membership fees and has sales greater than $500,000, (2) the client collects payment via check, has more than 50 transactions per month and has sales greater than $500,000, (3) the client is in any of the Manufacturing, Retail, Professional Services, Wholesale Trade, Restaurants, Cafes, and Bars or Health Care industries and they have sales greater than $500,000, or (4) the client has receivables management with another institution. Payables management is recommended if (1) the client has a high volume check payments (e.g., than 50 per month) and has sales greater than $500,000, (2) the client has a high volume ACH payments (e.g., than 10 per month) and has sales greater than $500,000, (3) the client pays by wire and has sales greater than $500,000, (4) the client has between 3 and 10 employees, (5) the client operates internationally, (6) the client is in any one of the Restaurants, Cafes, and Bars, Construction, Real Estate, Professional Services, Retail, Finance and Insurance, Manufacturing, Wholesale Trade, Import/Export, or Health Care industries and has sales greater than $500,000, or (7) the client has payables management with another institution.

Other examples of product recommendation logic include that a business purchase card is recommended if the client has sales greater than $500,000 and they issue cards to their employees. Fraud protection is recommended if the client (1) has a high volume of checks (e.g., 25 or more) and has sales greater than $250,000 or (2) has fraud protection with another institution. An employee benefits program (e.g., Key@Work®) is recommended if the client has more than 25 employees and is not in any of the General Small Business, Automotive, Hospitality and Entertainment, Household Services, Restaurants, Cafes, or Bars, and Retail industries. A commercial transactions account is always recommended.

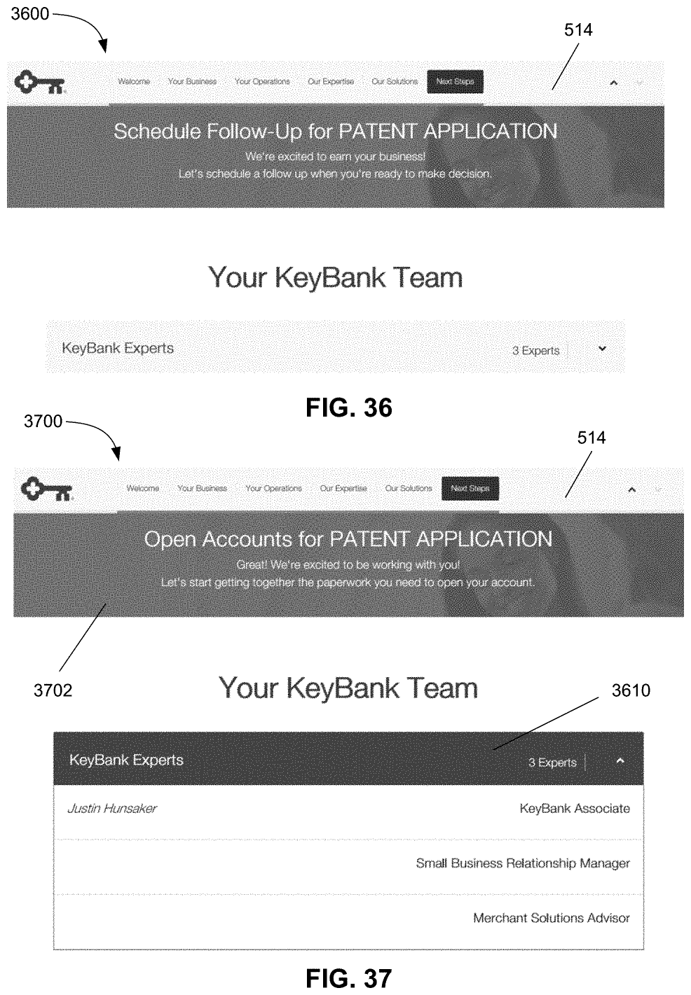

FIGS. 36-38 illustrate various screenshots for another feature 512 of the wellness review tool. In the illustrated embodiment, the feature 512 is labeled as “Next Steps” and involves the wellness review tool providing next steps based on the results of the four main features (502, 504, 506, 508). The header 514 shown in FIGS. 5-35 is also included in the screenshots for the feature 512, but the link that corresponds to the third feature 512 is highlighted, and the other links are not highlighted, which allows the user to recognize which portion of the wellness review tool the user is currently using.

Referring to FIG. 36, the screenshot 3600 shows the option of scheduling a follow-up interview, which is shown by reference character 3602. Referring to FIG. 37, the screenshot 3700 shows the option of opening accounts, which is shown by reference character 3703. In addition, the screenshots 3600, 3700 provide for a drop down menu 3610 for the user to see the client's team of experts.

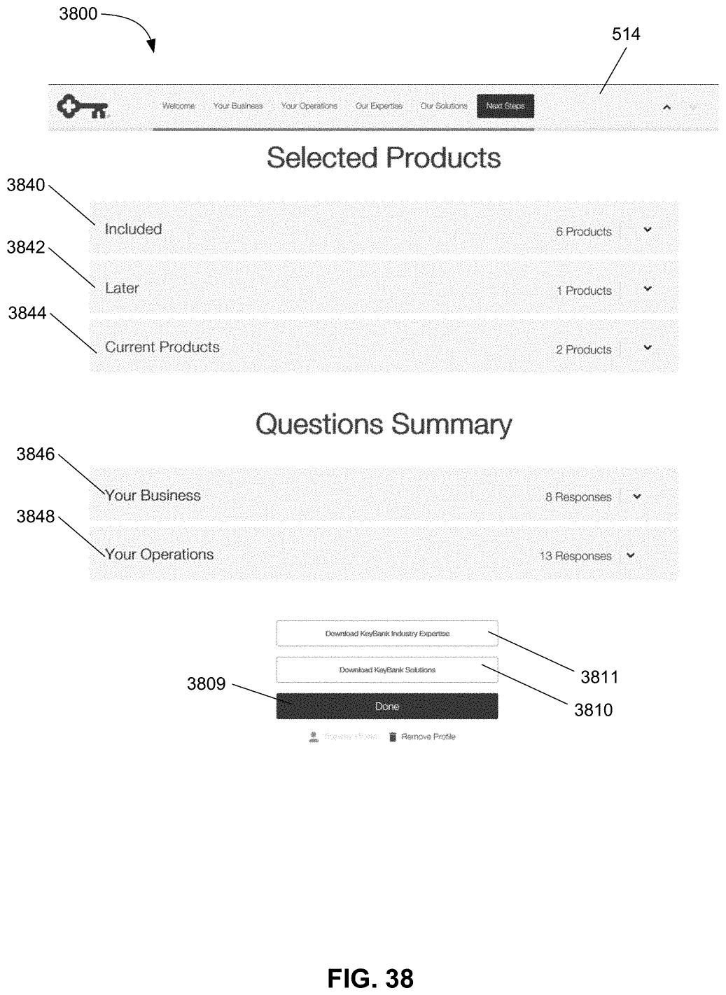

Referring to FIG. 38, the screenshot 3800 provides for an overview of the products selected (with various interests levels as described in the present application) and a summary of the questions asked to the client with regards to the first and second features 502, 504. That is, FIG. 38 includes a first drop down 3840 menu for products that were obtained by the client, a second drop down menu 3842 for products that the client may be interested in at a later date, a third drop down menu 3844 for products that the client currently has, a fourth drop down menu 3846 for a summary of the questions of the first feature 502, and a fifth drop down menu 3848 for a summary of the questions of the second feature 504. In addition, screenshot 3800 includes a “Done” link 3809 and two “download” links 3810 and 3811. The “Done” link 3809 will end the wellness review tool. The “download” links 3810 and 3811 will export information obtained from the client and provided by the wellness review tool. For example, this information may be exported to a document, such that the user can provide the document to the client.

In certain embodiments, the wellness review tool is configured such that the data obtained during the method 100 is saved in the memory 106 of the computing device 100. Subsequently, the wellness review tool can be used to provide the obtained data to the business consultant in various types of data sets. That is, the processor 102 can obtain this data from the memory 106 and provide data set(s) to the business consultant through the user interface 104. These data sets can be regarding the product(s) and/or service(s) that the clients are interested or not interested in, the product(s) and/or services(s) that clients from a specific industry are interested or not interested in, a correlation between a client's answers to the questions asked by the wellness review tool and the product(s) and/or service(s) selected by the client, or any other data set that is related to the data obtained by the wellness review tool and/or the products and services offered by the business consultant.

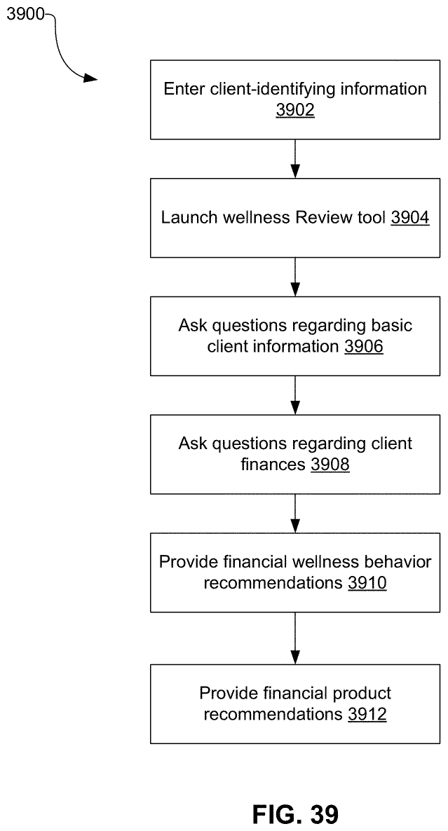

The following section describes another embodiment of a financial wellness review tool according to the present disclosure, this time targeted toward consumer clients. Referring to FIG. 39, an exemplary method 3900 for performing a wellness review of a consumer includes entering client-identifying information into a computing system (as shown at box 3902). Any suitable computing system can be used, such as, for example computing system 200 shown in FIG. 2. The client identifying-information can include, for example, personal information (e.g., name, email address, telephone number, account number, etc.). The method 3900 further includes launching a wellness review tool using the computing system (as shown at box 3904). The wellness review tool can include various features that allow data to be entered into the wellness review tool regarding the consumer, and the tool can include various other features that provide financial resources to the client. In certain embodiments, the method 3900 is completed by a client and a consultant using the wellness review tool together, and, in other embodiments, the client and the consultant may use the wellness review tool separately.

After the client's information is entered and the wellness review tool is launched, the method 3900 includes inputting answers into the wellness review tool in response to questions regarding the client's general information (as shown at box 3906). Exemplary general questions include the client's family status and basic questions regarding home and vehicle ownership.

The method 3900 further includes inputting answers into the wellness review tool in response to questions regarding the client's finances (as shown at box 3908). The questions can include, for example, the consumer's financial goals, spending habits, current assets and liabilities, financial emergency preparedness, or any other relevant information regarding the client's financial situation and behaviors.

In the steps of the method 3900 described above with reference to boxes 106 and 108, in certain embodiments, the consultant asks the questions to the client, and the business consultant inputs the answers into the wellness review tool. In other embodiments, the client receives the questions directly from the wellness review tool and inputs the answers directly into the wellness review tool. In some embodiments, the client and the consultant are at the same location (e.g., a bank) when inputting the answers to the questions, and, in other embodiments, the client can input answers to the questions while at a remote location from the consultant.

After inputting answers into the wellness review tool regarding the client's information and financial situation and behaviors, the method 3900 includes providing the client with a set of financial wellness recommendations (as shown in box 3910), which include behaviors the client can undertake to improve their financial situation and better meet their financial goals. For example, based on the inputted answers, the wellness review tool may suggest that the client pay down certain debts first, contribute more or less to retirement, or increase emergency savings. Exemplary behavioral recommendations, and the process for determining these recommendations, is described more fully below.

The method 3900 further includes the wellness review tool providing financial product recommendations to the client (as shown in box 3912) based at least in part on the answers inputted into the wellness review tool (as discussed with reference to boxes 3906 and 3908). Such financial products can include, for example, a new checking or savings account, a new credit card, a new or refinanced loan, or an overdraft protection plan.

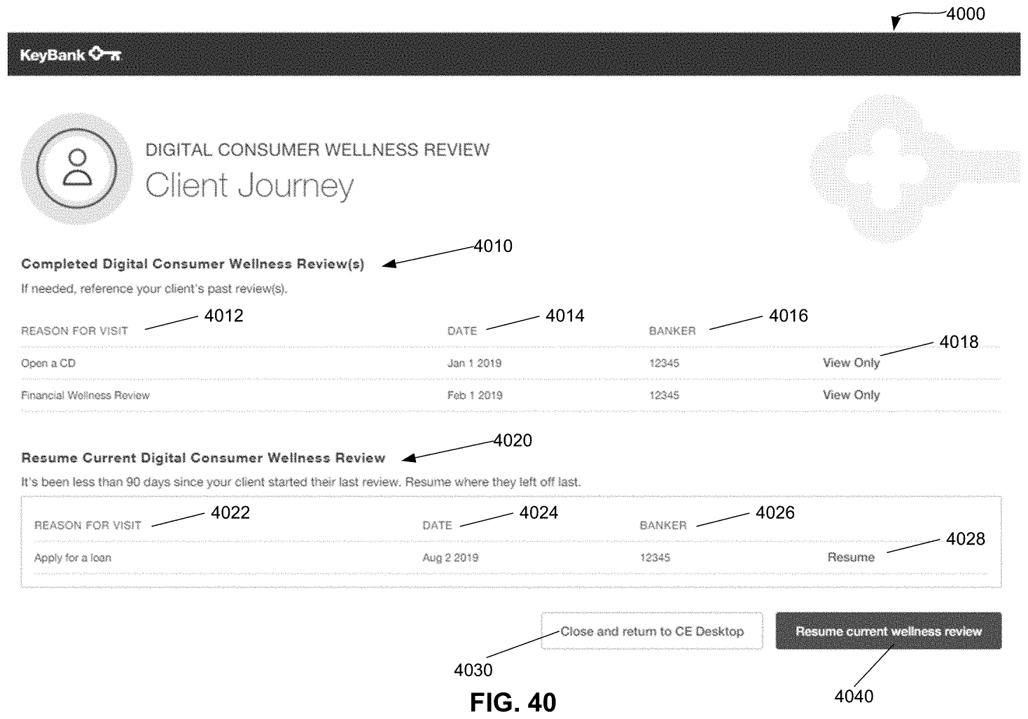

FIGS. 40-48 illustrate various screenshots for a user interface (e.g., any user interface described in the present application) of a computing device (e.g., any computing device described in the present application), in which the screenshots illustrate various features of an exemplary embodiment of a wellness review tool. The wellness review tool shown in 40-48 will be described with reference to the method 3900 described in FIG. 39 and the computing device 200 described with reference to FIG. 2. However, the wellness review tool is not limited to the method 3900 and computing device 200. Moreover, FIGS. 40-48 are only a selection of screenshots for the user interface, and do not represent the entirety of the user interface. Screens similar to those shown in the figures may be used to provide a user with the questions and information described below.

As shown in FIG. 40, an exemplary user interface includes a start screen 4000, which in this embodiment is labeled “Client Journey.” The exemplary start screen 4000 includes a prior review component 4010, which allows the user to see basic information about previously completed financial wellness reviews using the present system and method. Exemplary information listed for prior-completed reviews includes, but is not limited to, a reason for the review 4012, the date of the review 4014, and an identification of a consultant that assisted with the review 4016. The prior review component 4010 may also include a link 4018 that allows a user to view the inputs and/or results of the respective prior review.

The exemplary start screen 4000 also includes a pending review component 4020 that allows a user to see the same basic information listed above (reason for the review 4022, date of the review 4024, and identification of a consultant that assisted with the review 4016) for a started but not completed review, along with a link 4028 allowing a user to resume and complete the pending review. The exemplary start screen 4000 further includes an exit button 4030 (or other interactive link) that allows a user to exit the user interface, as well as a resume button 4040 (or other interactive link) that allows a user to resume and complete the pending review. In some embodiments, where the client has no pending reviews, the exemplary start screen 4000 may include a button or other interactive link to begin a new wellness review.

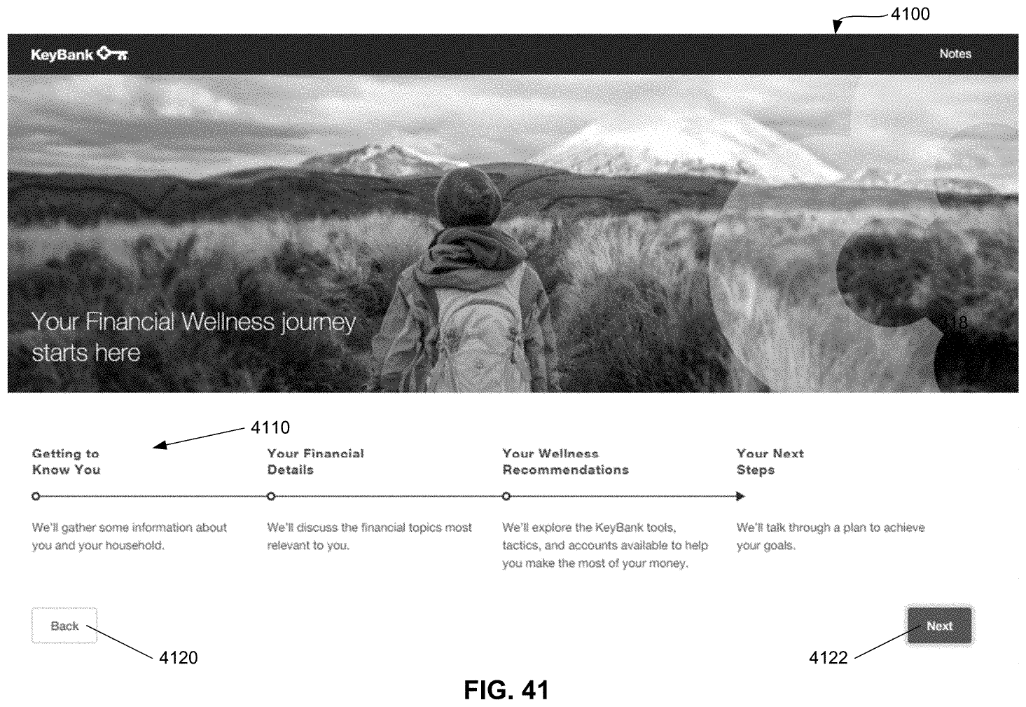

As shown in FIG. 41, an exemplary user interface may include an introduction screen 4100, which provides an outline 4110 of the steps a client will experience while using the financial wellness review tool. The introduction screen 4100 may also include navigations buttons 4120 and 4122 that allow a user to navigate forward and backward, respectively, to other screens of the review.

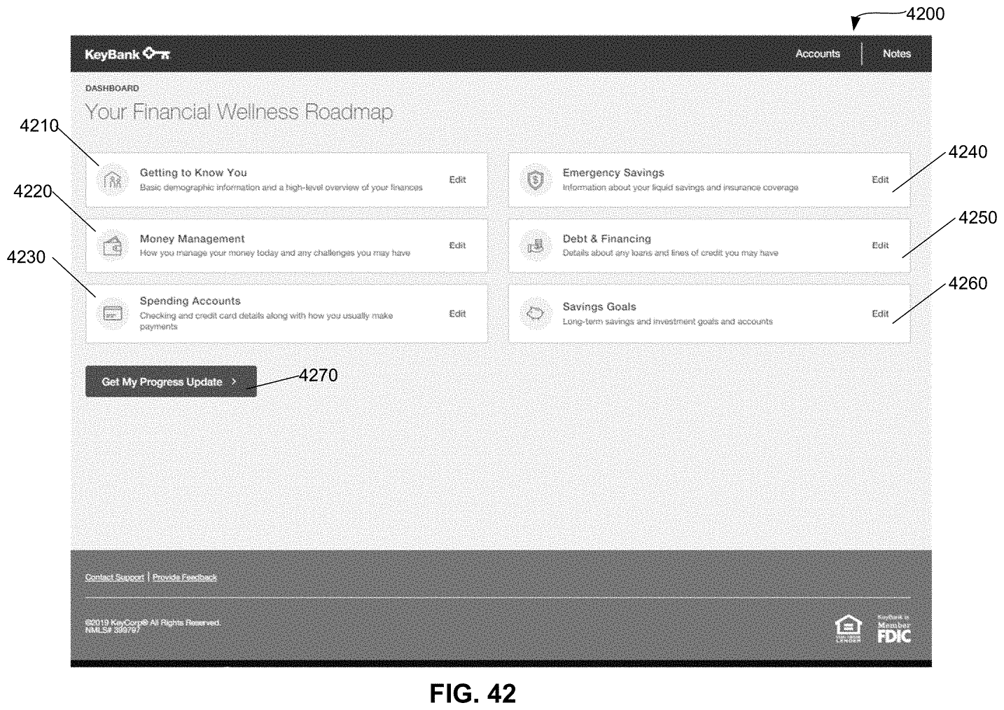

Referring to FIG. 42, the exemplary user interface includes a dashboard screen 4200 that allows a user to navigate to several screens having categories of questions used for input into the system and method for eventual use in calculating recommendations. The exemplary categories listed in dashboard screen 4200 each have buttons or links associated with them and include “Getting to Know You” button 4210, “Money Management” button 4220, “Spending Accounts” button 4230, “Emergency Savings” button 4240, “Debt & Financing” button 4250, “Savings Goals” button 4260. Each of these categories is described in more detail below. It should be appreciated that the system and method is not limited to categories described herein, and other categories of questions are contemplated. The exemplary dashboard screen 4200 further includes a progress update button or link 4270, which allows the client to navigate to a screen, described in more detail below, showing changes in the client's financial position since prior reviews.

As described above, the dashboard screen 4200 provides links to several categories of questions used to inform the system and method for client recommendations. It should be understood that any or all of the questions may be required fields, meaning that the user must provide an answer before proceeding to further questions, or before completing the wellness review. As a first example, the dashboard screen 4200 includes a link 4210 to a “Getting to Know You” category of questions. The “Getting to Know You” questions relate mostly to background and demographic questions relating to the client. For example, questions might include, but are not limited to, the duration of the client's relationship with the consultant, the client's employment status and information, whether the client's employer has a relationship with the consultant (e.g., an employer benefit program), the client's marital status and family information, whether the client owns a home or rents, whether the client owns or leases a vehicle, and a list of the client's financial accounts.

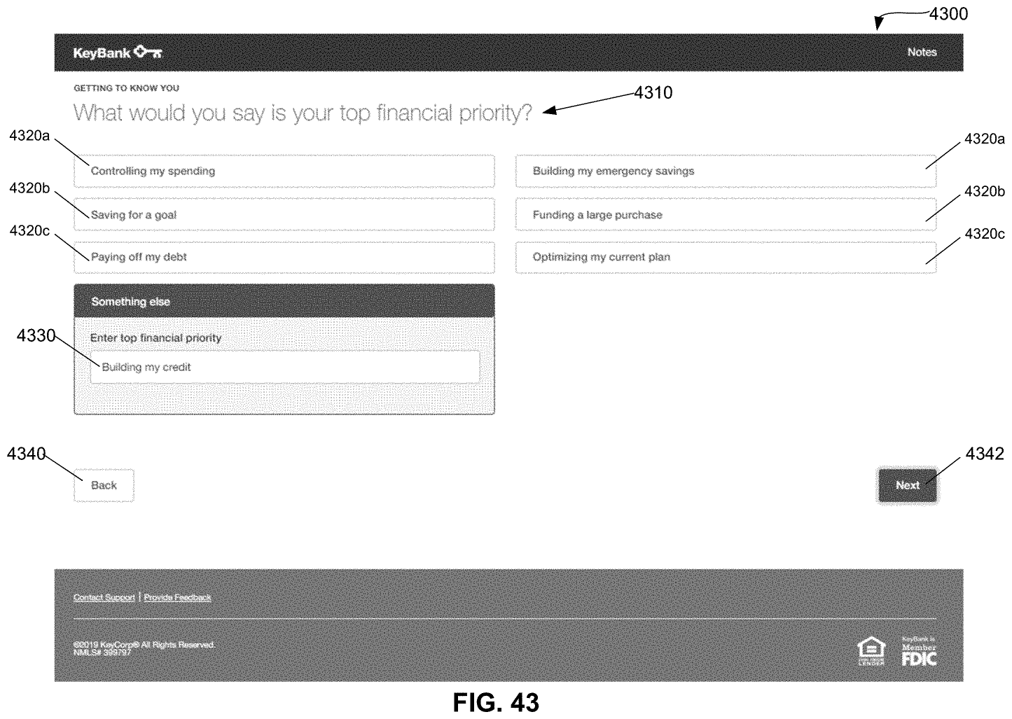

FIG. 43 depicts an exemplary screen 4300 in the “Getting to Know You” category that asks the question 4310 “What would you say is your top financial priority?” A set of form answers 4320a-4320f may be provided for the user to select, as well as a custom answer field 4330 where a user can manually enter a text answer using a keyboard, dictation or other know means for text entry. The screen 4300 also includes navigation buttons 4340 and 4342 for returning to a previous screen or navigating to a next screen. Note that all the other screens described herein may include navigation button or links like buttons 4340 and 4342, and/or may contain a link or button returning the user to the dashboard screen 4200.

As another example, the dashboard screen 4200 includes a link 4220 to a “Money Management” category of questions. The “Money Management” questions ask high-level questions about the client's financial behaviors including whether the client is spending more than they earn, whether the client tracks income and expenses, whether the client is comfortable using technology to manage their finances, what financial challenges the client is facing, and what is important to the client regarding their cash flow (e.g., paying off debt, increasing savings, increasing spending, etc.).

As a further example, the dashboard screen 4200 includes a link 4230 to a “Spending Accounts” category of questions. The “Spending Accounts” questions ask more specific questions about the client's current financial accounts, including whether the client would prefer accounts with overdraft, details of the client's current checking accounts, including balance, usage information, whether the account is used for direct deposit, and whether the client writes checks from that account. The “Spending Accounts” questions may further inquire about a client's credit cards, including, without limitation, whether the client pays off their cards every month, the bank that issued the card, revolving balance and interest rate and other related information.

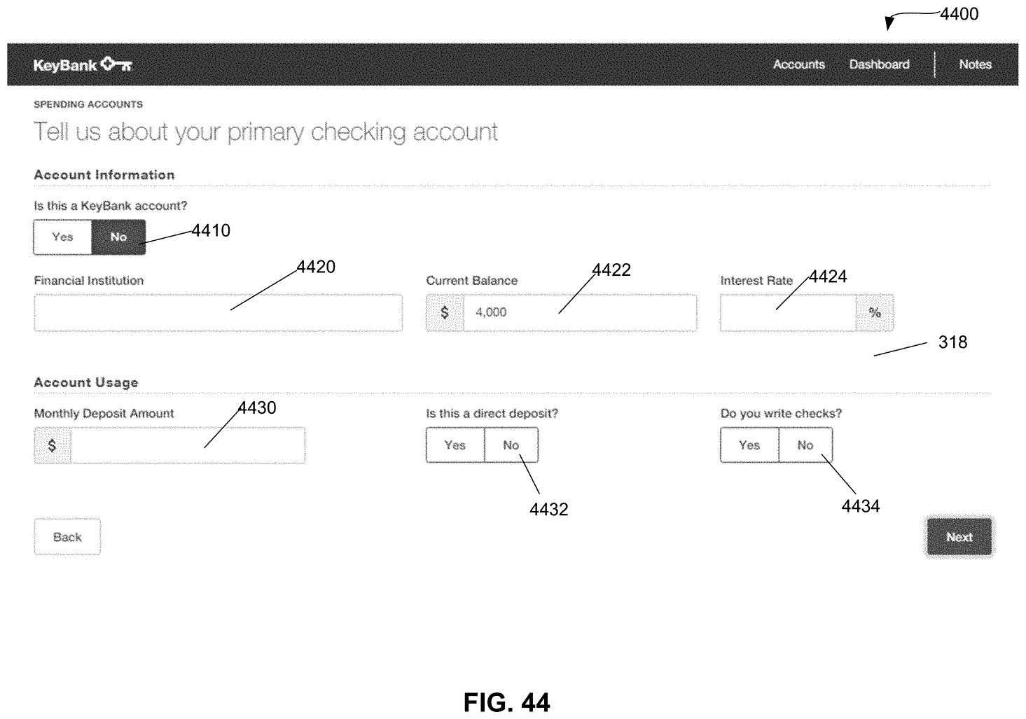

For example, FIG. 44 illustrates an exemplary spending accounts screen 4400, inquiring about the client's primary checking account. The exemplary spending accounts screen 4400 includes a selector 4410 to select whether the account is with the consultant. If not, the client can enter the name of the financial institution holding the account in financial institution box 4420. If account is with the consultant, the spending accounts screen 4400 may include a field or dropdown (not shown) for selecting an account type, if the consultant has specific account types. The spending accounts screen 4400, further includes fields for inputting additional information about the account, such as balance field 4422 and interest rate field 4424. The spending accounts screen 4400 also includes fields for inputting account usage information, such as a monthly deposit amount field 4430, a selector 4432 for selecting whether the account is used for direct deposit, and a selector 4434 for selecting whether the client writes checks from the account.

The dashboard screen 4200 may further include a link 4240 to an “Emergency Savings” category of questions. The “Emergency Savings” questions concern the client's ability to manage a financial emergency and may include asking how the client believes they would handle an emergency and details of the client's current savings accounts, including balance and interest rate. The “Emergency Savings” questions may also include additional details about the client's income, such as salary and monthly take-home pay. Finally, the “Emergency Savings” questions may include information about the client's insurance and estate plans, such as questions about health insurance, life insurance, disability insurance, home or renters' insurance, auto insurance, and wills and trusts.

The dashboard screen 4200 may further include a link 4250 to a “Debt & Financing” category of questions. The “Debt & Financing” questions concern details about the client's loans and other financial liabilities, and may include the client's feelings about their current debt, the client's credit score, details of home loans, details about vehicle loans, and details about other loans (e.g., personal or student loans).

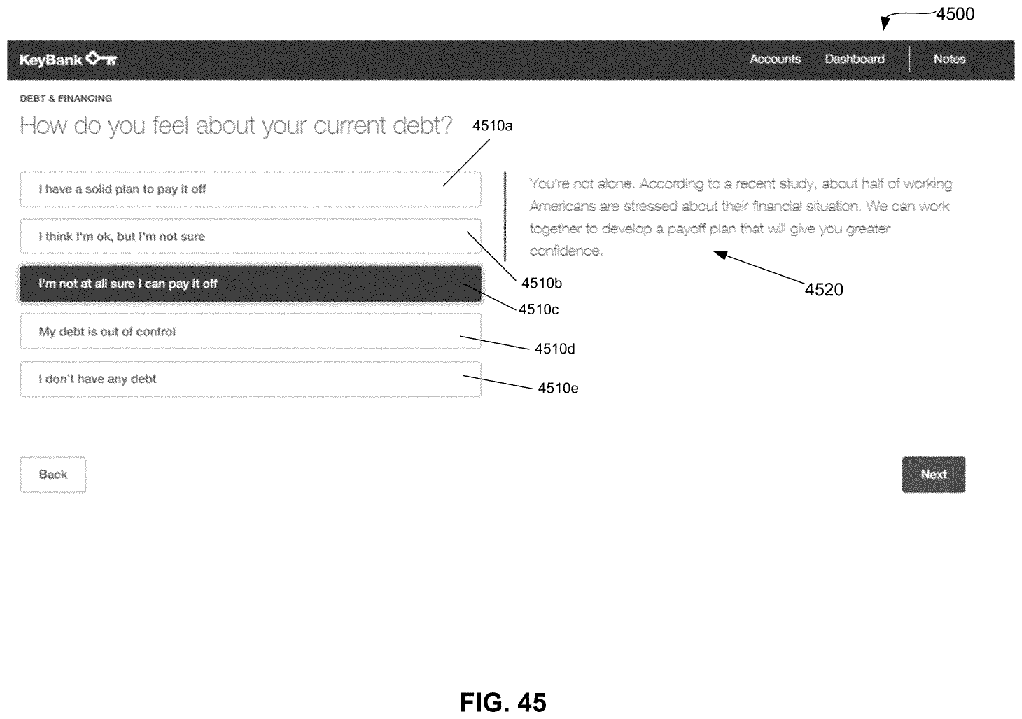

For example, FIG. 45 illustrates an exemplary “Debt & Financing” screen 4500, asking how the client feels about their current debit satiation. The “Debt & Financing” screen 4500 includes a set of answers 4510a-4510e, which are selectable buttons or links. The screen 4500 may further include explanatory text 4520, which provides information regarding the client's selection of an answer from answers 4510a-4510e.

The dashboard screen 4200 may further include a link 4260 to a “Savings Goals” category of questions. The “Savings Goals” questions concern the client's long terms investment goals and accounts. It may ask how the client feels about their retirement situation and details about the client's investment accounts, including retirement savings accounts, investment accounts and certificates of deposit (CDs).

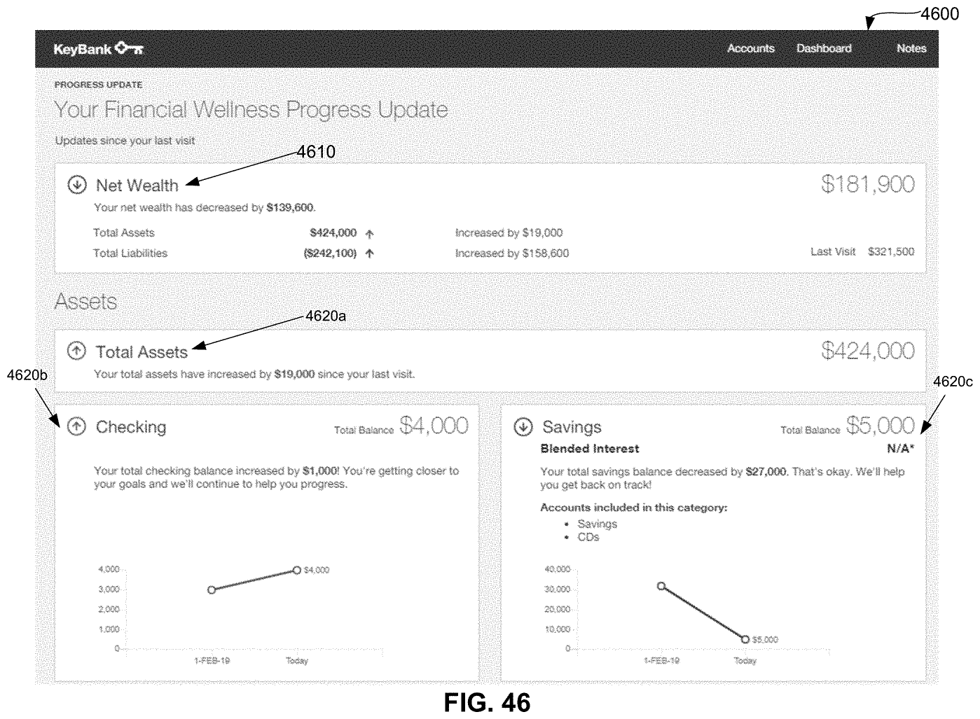

The dashboard screen 4200 may also include a button or link 4270 to a financial wellness progress update screen. FIG. 46 depicts an exemplary financial wellness progress update screen 4600. The financial wellness progress update screen 4600 provides statistics regarding the change in the client's financial position in light of prior financial wellness reviews. For example, financial wellness progress update screen 4600 may include a net wealth update section 4610 that includes information regarding the client's change in net wealth, such as the present total net wealth, the net wealth in the prior visit, the amounts of the components of the net wealth (assets and liabilities) the total amount of the change, and the amount of the change for each of the components. The net wealth update section 4610 may use indicators and/or colors to denote the changes to make them clearer to the client, for example red for a decrease and green for an increase.

The financial wellness progress update screen 4600 may further include detailed sections relating to wealth components, such as asset sections 4620a-4620c. The exemplary progress update screen 4600 includes an asset summary component 4620a, which summarized the client's total assets and change in assets. The asset sections may also include account summary sections, such as checking summary section 4620b and savings summary section 4620c. The account summary sections may include information such as account balance, change in account balance over time (including a visual representation such as a graph), and a list of accounts included in the calculations for each such summary section. The financial wellness progress update screen 4600 may include sections similar to those shown in 4620a-4620c for financial liabilities such as loans and other debts.

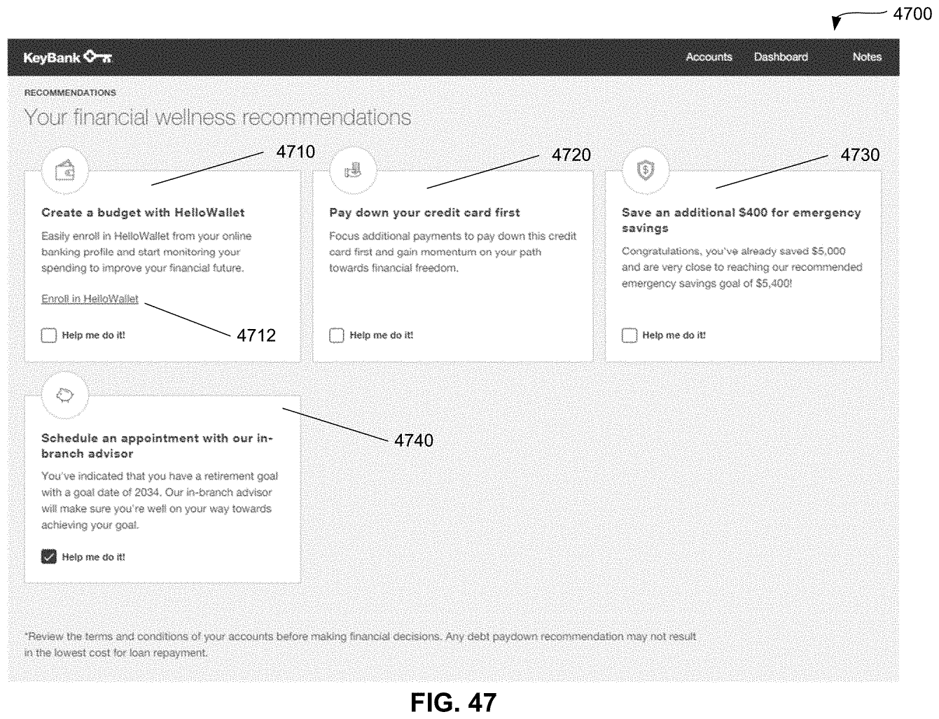

Once the client has completed the several question screens accessed via the dashboard 4200, as described above, the financial wellness tool may use the inputted information to derive a set of recommended behaviors and financial products or services for the client. FIG. 47 illustrates an exemplary financial recommendation screen 4700. The exemplary financial behavior recommendation screen 4700 includes four recommendations 4710, 4720, 4730 and 4740, but as explained more fully below, many other recommendations may appear on the financial recommendation screen 4700 depending on the specific inputs by the user. Each of the recommendations, where applicable, may include a link or button to take further action regarding that recommendation. For example, recommendation 4710, which recommends enrolling in an online budgeting system, includes a link 4712 to enroll that system. Moreover, the recommendations may include checkboxes or other indicators that allow the client to inform the consultant that he or she would like further assistance regarding that recommendation. In some embodiments, the client's indicating that they want further assistance may result in further information regarding that recommendation automatically being physically printed for the client at end of the review or transmitted to the client via email or other electronic means. In some embodiments, the client's indicating that they want further assistance may result in the client's account being flagged for a follow-up communication from the consultant or an affiliate of the consultant.

The recommendations set forth in financial recommendation screen 4700 are the result of a complex logic based on the answers the client provides to the various questions presented via the user interface as explained above. Exemplary logic is described below. For example, in an exemplary budgeting logic, the wellness review tool will recommend a web-based budgeting tool (e.g., HelloWallet) if the client answers that they are not currently using one and that the client is comfortable with digital financial tools. If the client is not comfortable with digital tools, the wellness review tool will recommend an in-person meeting with a budgeting expert. If the client is already using a web-based budgeting tool, the wellness review tool will recommend a review of the existing on-line budget.

As a further example of recommendation logic, a checking account logic will recommend certain types of checking accounts based on the client's age, current checking balance and check-writing habits. If the client is between 16 and 24 years of age, a student checking account is recommended. Otherwise, different levels of checking account (i.e., having different benefits and privileges) are recommended based on the client's current account balance. For small balances, the account type will depend on the client's monthly deposit amount and whether they write checks.

As another example of recommendation logic, a credit card logic will recommend a rewards credit card if the client has no current credit cards or has no revolving debt on existing cards. If the client has a small revolving debt (e.g., less the $5,000), then a different non-rewards credit card is recommended. Finally, if the client has a large revolving debt, no credit cards may be recommended.

As one more example of recommendation logic, a debt paydown logic will only consider debt with active balances. The wellness review tool will recommend that the lowest debt be paid down first. In the event of a tie, it will be recommended that the debt with the highest interest rate be paid down first. In the case of a further tie, the wellness review tool will recommend the first listed debt.

As an additional example of recommendation logic, an emergency savings logic first determines a recommended emergency savings amount as one of: (1) three times monthly take-home pay if the client does not own a car or home; (2) four and half times monthly take-home pay if the client owns one of a car or a home; and (3) six times monthly take-home pay if the client owns both a car and a home. Next, the client's total savings is calculated by adding all amounts in all listed savings accounts. Finally, the calculated recommended amount and total savings are compared. If the client has less than the recommended amount, the wellness review tool will recommend that the client build savings. If the client has more than $10,000 over the recommended amount, a meeting with a financial advisor will be recommended. If the client has less than $10,000 over the recommended amount, no recommendation will be given, and/or the client may be presented with message stating that they are on track with their emergency savings goals.

As one further example of recommendation logic, a savings account logic provides a generic savings account recommendation if the client has no current savings accounts. If the client has existing savings accounts, then savings accounts or different levels (i.e., having different benefits and privileges) are offered based on the client's current total savings balance.

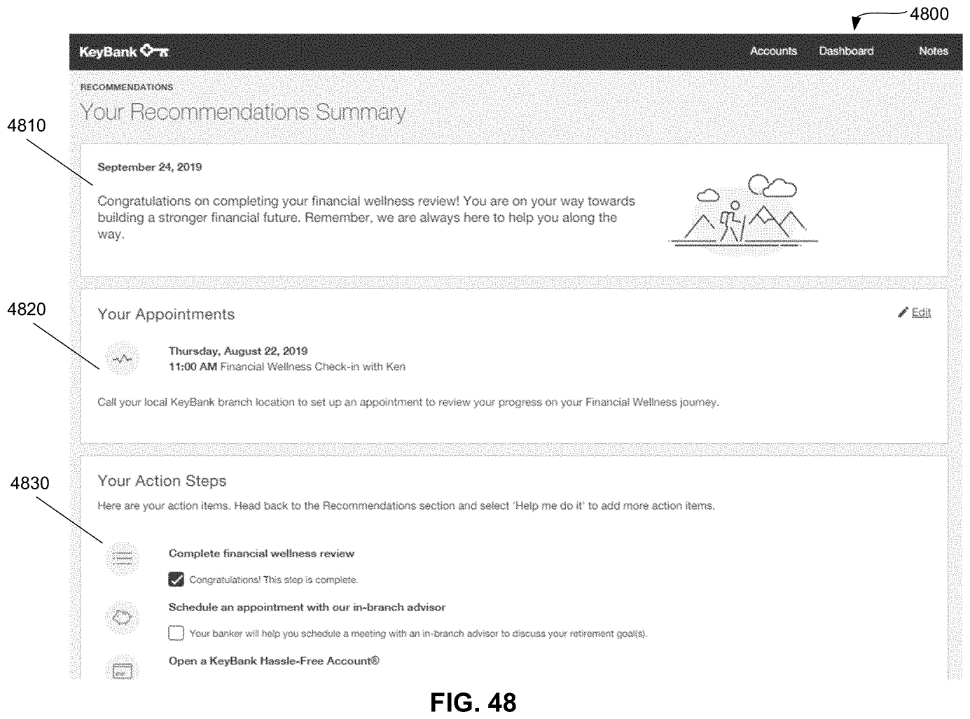

Finally, at the end of the client's use of the financial wellness review tool, the user interface may provide a summary screen 4800, as depicted in FIG. 48. The summary screen 4800 may include several screens, such as confirmation text 4810, which provides the date of the review and text confirming completion of the review. The summary screen 4800 may also include an appointments section 4820 that provides a summary of upcoming appointments between the client and consultant. The summary screen 4800 may further include an action steps section 4830 which presents a list of action items for the client to complete as a result of the wellness review. The action steps section 4830 may also include an indicator as to whether each action step has been completed.

Some of the steps, acts, and other processes and portions of processes are described herein as being done “automatically.” In the alternative, or in addition thereto, those steps, acts, and other processes and portions of processes can be done with one or more intervening human acts or other manual acts that eventually trigger the mentioned step(s), act(s), and/or other process(es) and/or process portion(s).

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. Accordingly, departures may be made from such details without departing from the spirit or scope of the applicant's general inventive concept.

1. A system for providing automated financial recommendations to a business, the system comprising:
a user interface having
a plurality of questions regarding the business's finances and an input for the business to provide answers to the plurality of questions,
an industry selector configured to input a specific industry for the business, and
an output display;
a memory having stored thereupon
data relating to general financial information for a plurality of industries, and
a set of rules that define output financial recommendations based on the data relating to general financial information for a plurality of industries and the answers to the plurality of questions;
a processor configured to calculate and generate to the output display a set of financial recommendations based on the set of rules, the specific industry, and the answers to the plurality of questions.

2. The system of claim 1, wherein the processor is further configured to calculate and generate to the output display a set of financial experts suited to the business based on both the specific industry answers to the plurality of questions.

3. The system of claim 1, wherein the processor is further configured to calculate and generate to the output display a set of statistics relating to finances in the specific industry.

4. The system of claim 1, wherein the plurality of questions includes questions about the business's characteristics and questions about the business's operations.

5. The system of claim 1, wherein the processor is further configured to export a report listing the set of financial recommendations to one of an electronic file or a printed copy.

6. The system of claim 1, wherein the plurality of questions includes one of: (a) questions about the motivation for starting the business, (b) goals and challenges of the business, (c) the business's organization, (d) the business's growth, (e) the number of employees, and (e) annual sales.

7. The system of claim 1, wherein the plurality of questions includes one of: questions about (a) how customers pay the business, (b) where customers pay the business, (c) the number of transactions per month, (d) the speed at which customers pay, (e) whether the business pays with checks, (f) whether the business pays with ACH, (g) how the business handles accounting, (h) financing needs for the business, and (i) how the business is planning savings.

8. The system of claim 1, wherein calculating a set of financial recommendations comprises recommending payables management based on the business's check-cashing volume, gross sales, ACH payment volume, wire payment volume, number of employees, international operations, and the business's industry.

9. The system of claim 1, wherein calculating a set of financial recommendations comprises recommending a business loan based on one or more of whether the business is looking to expand, the frequency of the business's inventory purchases, and the business's industry.

10. The system of claim 1, wherein calculating a set of financial recommendations comprises recommending a type of rewards checking account based on one or more of whether the business's volume of transaction per month, whether merchant services was recommended for the business and whether the business is looking for rewards.

11. A system for providing automated financial recommendations to a consumer, the system comprising:
a user interface having
a plurality of questions regarding the consumer's current financial assets and liabilities and an input for the consumer to provide answers to the plurality of questions regarding the consumer's current financial assets and liabilities,
a plurality of questions regarding the consumer's financial behaviors and an input for the consumer to provide answers to the plurality of questions regarding the consumer's financial behaviors, and
an output display;
a memory having stored thereupon a set of rules that define output financial recommendations based on the answers to the plurality of questions regarding the consumer's current financial assets and liabilities and the plurality of questions regarding the consumer's financial behaviors;
a processor configured to calculate and generate to the output display a set of financial recommendations based on the set of rules, the answers to the plurality of questions regarding the consumer's current financial assets and liabilities and the plurality of questions regarding the consumer's financial behaviors.

12. The system of claim 11, wherein the processor is further configured to export a report listing the set of financial recommendations to one of an electronic file or a printed copy.

13. The system of claim 11, wherein the processor is further configured to calculate and generate to the output display a summary of changes to the customer's financial assets and liabilities by comparing the consumer's past and present financial assets and liabilities.

14. The system of claim 11, wherein the plurality of questions regarding the consumer's current financial assets and liabilities includes one or more of: questions about (a) the consumer's checking accounts, (b) the consumer's savings accounts, (c) the consumer's loans, and (d) the consumer's retirement savings.

15. The system of claim 11, wherein the plurality of questions regarding the consumer's financial behaviors includes one or more of: questions about (a) the consumer's financial priorities, (b) the consumer's feelings about their debt, (c) the consumer's savings goals, and (d) the consumer's check-writing habits.

16. The system of claim 11, wherein calculating a set of financial recommendations comprises recommending a specific a checking account type based on the consumer's age, current checking balance and check-writing habits.

17. The system of claim 11, wherein calculating a set of financial recommendations comprises:
Calculating a recommended emergency savings amount based on the client's take-home pay and current loans, and
Calculating an emergency savings behavioral recommendation by comparing the recommended emergency savings amount to a pre-set range stored on the memory.

18. The system of claim 11, wherein calculating a set of financial recommendations comprises recommending a debt paydown order based on the active debt balance and the interest rate on the debt.

19. The system of claim 11, wherein calculating a set of financial recommendations comprises recommending a debt paydown order based on the active debt balance and the interest rate on the debt.

20. A method for providing automated financial recommendations to a client, the method comprising:
storing to a memory a set of rules that define output financial recommendations based on a plurality of questions regarding the client's finances;
providing the plurality of questions regarding the client's finances to a user via a user interface;
receiving answers from the user to the plurality of questions via the user interface;
storing the answers to a memory;
calculating a set of financial recommendations based on the set of rules and the answers provided by the user;
generating a report displaying the set of financial recommendations via the user interface.
